(19) United States
(12) Patent Application Publication
(10) Pub. No.: US 2005/0125083 A1
(43) Pub. Date: Jun. 9, 2005

(54) Automation apparatus and methods

(76) Inventor: Frederick J. Kiko, Carlsbad, CA (US)

Correspondence Address: GAZDZINSKI & ASSOCIATES, Suite 375, 11440 West Bernardo Court, San Diego, CA, 92127, US

(21) Appl. No.: 10/986,234

(22) Filed: Nov. 9, 2004

Related U.S. Application Data
(60) Provisional application No. 60/519,068, filed on Nov. 10, 2003.

(51) Int. Cl. G05B 11/01

(52) U.S. Cl. 700/19; 700/275; 700/20

(57) ABSTRACT

A system and associated components for providing substantially automated operation and control of various functions within a premises, such as a residence. In one embodiment, the system comprises a server-based system which is adapted for low cost, ease of installation and operation, and ready repair by the premises owner. Indigenous wiring within the premises is used to a large extent in order to further reduce installation cost and facilitate ready integration by the user. Methods for installing and operating the aforementioned system and components are also described.

### PRIORITY

This application claims priority to U.S. Provisional Application Ser. No. 60/519,068 filed Nov. 10, 2003 entitled “IMPROVED AUTOMATION APPARATUS AND METHODS”, incorporated herein by reference in its entirety

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to the field of automation, and specifically to an integrated automation system (and its individual components) such as might be used in a home, office, or other premises.

2. Description of Related Technology

Traditional approaches to premises (e.g., home or office) automation generally involve either (i) installing the automation system into an existing premises, or (ii) designing and implementing the system during construction of the premises. Since most homes and other premises are not new construction, there is a vast pool of existing premises that require automation systems that can be installed after the fact.

Such post-construction systems typically integrate many different manufacturers' products into a single ad hoc system. This integration almost always introduces an element of complexity into the system, since the components forming the system each have their own operating environments, control functions, and the like. While some “high-end” customers are satisfied with such complex “composite” systems, many others yearn for a simpler, more reliable, and more intuitive approach.

Many of the deficiencies relating to the reliability of such prior art systems concerns the control of many different manufacturer's remote control technologies such as, e.g., infrared (IR) systems. Typically an IR control system must be installed and connected to each of the manufacturer's IR input LEDs using some fastening mechanism (e.g., double sided tape or Velcro attachments) to hold a device in place, with cabling routed to a master controller. A Universal remote control is then added and programmed by a technician (typically at very significant cost) to control at least a portion of the devices. Most such technician-installed systems also require a second (or even third) visit by the technician to re-program the system, e.g., due to one of the system toggles (on/off) getting out of sequence, or to provide additional training to the user(s). These installations can also be unsightly, and/or require significant (and often irreversible) modifications to the user's premises.

Furthermore, many users of such prior art systems simply stop using them due to the high level of complexity and expertise required for proper operation. This problem is especially acute for more senior segments of the population, who may not have the innate level of familiarity or understanding of computers and electronic systems that younger generations have.

Methods for remotely controlling devices and systems in a home or business environment are also known in the prior art. Some of these methods employ signaling over AC power lines, while others employ signaling over communications channels or media installed specifically to transport the control signals. For example, in one prior art configuration, an AC power line signaling controller generates command messages that are transmitted over the AC power distribution network of the premises to one or more of a plurality of AC power line signaling interfaces. Each AC power line signaling interface has a receiver that is capable of detecting the control signals on the AC power line, and receiving the messages that are sent by the controller. Each signaling interface is coupled to a device or system that is to be controlled, including lighting, appliances, the premises HVAC system, etc. This signaling method also provides an addressing method so that the controller can target one or more of the plurality of AC power line signaling interfaces to receive a specific message. The AC power line signaling interfaces may or may not send a response message upon receipt of a command message.

Generally, the prior art signaling controller (whether AC power line or another type) is a stand-alone device which includes its own controls and operating environment. Some variants also include a user interface into the signaling controller to allow for remotely controlling the home automation system using a remote device such as a telephone (or even a remote computer system).

However, as previously described, these AC power distribution-based systems lack the desired ease of installation, control and operation, as well as lacking integration (centralization) with other control functions of the user's premises, thereby making their operation and programming unnecessarily complex.

Hence, what is needed is a greatly simplified yet fully functional premises automation system and associated methods of operation. Such system and methods would also ideally allow a user to perform the installation of the system themselves (or with minimal assistance), and also not require any significant modification to the premises infrastructure such as running cabling, electrical system modifications, drywall or plumbing work, etc.

The ideal system would also be highly modular in nature, such that each user could configure their premises (and equipment operating therein) according to their particular desires and equipment configuration. This modularity would also include the ability to add more or different automation functions over time without having to modify the rest of the system.

### SUMMARY OF THE INVENTION

The present invention satisfies the aforementioned needs by providing improved apparatus and methods for, inter alia, automation within a home, office, or other premises.

In a first aspect of the invention, an improved automation system for use on a premises is disclosed. In one exemplary embodiment, the system is adapted for residential use, and comprises a plurality of self-installable components and a server device adapted to provide a plurality of monitoring and control functions. Many of the devices are networked or otherwise communicate with the server via existing wiring within the residence (such as telephone wiring, low-voltage AC wiring, etc.), thereby making installation of the system as easy and low-cost as possible.

In a second aspect of the invention, an improved controller device for use in an automation system is disclosed. In one exemplary embodiment, the controller comprises a server comprises a PC-like device with highly compact and modular architecture, which is adapted for user (self) installation. The server interfaces with a variety of different existing or installed wiring systems and components, and provides software-implemented control functionality, monitoring, alerts, communications, etc. Set-up, self testing, and diagnostic functions are also provided to permit the user to rapidly install, operate, and repair the sever device, thereby obviating expendive service calls.

In a third aspect of the invention, an improved touch-screen interface module for use in a premises is disclosed. In one exemplary embodiment, the module is a universal power line bus (UPB) device adapted for wall mounting. The module is made fully programmable and readily installable by a user, and may also include IR, temperature control, and/or motion detection functionality. Hence, the module may be used for indication, sensing, and control functions within the system.

In a fourth aspect of the invention, an improved wire architecture and devices are disclosed. In one exemplary embodiment, IDC (insulation displacement contacts) adherent and self-installable products are provided, including paintable flat tape wire, which facilitate user self-installation of various components including lighting fixtures, water leak sensors, motion detectors, etc.

In a fifth aspect, an improved “universal” plug-in module for use with the automation system is disclosed. In one exemplary embodiment, the module comprises a housing with internal configuration adapted to accommodate a variety of different interfaces including three-prong, two-prong, DB-9, RJ, etc. The module conveniently plugs into a standard low-voltage wall outlet or similar, and provides signal interconnection between various of the system components via, e.g., the installed low-voltage wiring within the premises.

In a sixth aspect of the invention, an improved bobbin electrical device is disclosed. In one exemplary embodiment, the device comprises a small-size and low-cost current transformer which may be used with the aforementioned automation system. The exemplary current transformer provides low-cost current sense capability for, inter alia, power consumption and electrical fault monitoring.

In a seventh aspect of the invention, an improved method of installing the foregoing system and associated components is disclosed. The method generally comprises: determining scope and location of wiring within the site; determining the desired functionality for the system; positioning at least one server in a location of the site having access to both installed wiring and power; positioning one or more modules in operative communication with respective ones of said wiring and power outlets; and operating the system substantially using the server and modules.

In an eighth aspect of the invention, an improved premises hot water recirculation system is disclosed. In one embodiment, the system is user-installable, and comprises a pump with temperature sensor and check valve which is fluidically interposed between the hot and cold water supply lines to, e.g., the sink or other water outlet farthest from the premises water heater.

These and other aspects of the invention will be readily appreciated by those of ordinary skill provided the present disclosure.

### BRIEF DESCRIPTION OF THE DRAWINGS

The features, objectives, and advantages of the invention will become more apparent from the detailed description set forth below when taken in conjunction with the drawings, wherein:

FIG. 1 is a functional block diagram of a first exemplary configuration of an automation system according to the present invention.

FIG. 2a is a front perspective view of a first exemplary embodiment of a server device according to the present invention.

FIG. 2b is a rear perspective view of the server device of FIG. 2a.

FIG. 2c is a front perspective exploded view of the server device of FIG. 2a, showing the various constituent components.

FIG. 2d is a rear perspective exploded view of the server device of FIG. 2a.

FIG. 2e is a front perspective view of the server device of FIG. 2a, showing the various internal components and electronics cards of the device.

FIG. 2f is a functional block diagram of the exemplary server of FIG. 2a.

FIGS. 2g-2j are various views of one exemplary configuration of a component mounting system for the server devices of FIGS. 2a-2e.

FIG. 3a is a front perspective view of a first exemplary embodiment of a networked (e.g., Ethernet) camera device according to the present invention.

FIG. 3b is a front perspective view of a first exemplary embodiment of a flood light camera device (with motion detection and light) according to the present invention.

FIG. 3c is a composite elevational and schematic view of a first exemplary embodiment of an external HomePlug-based access and control module (e.g., doorbell system) according to the present invention.

FIG. 3d is a composite elevational and schematic view of another exemplary embodiment of an external access and control module (e.g., doorbell system) utilizing powerline (e.g., UPB) technology.

FIG. 4a is a front perspective view of a first exemplary embodiment of a fully assembled plug-in module according to the present invention.

FIG. 4b is a front perspective exploded view of the module of FIG. 4a, showing the various constituent components.

FIG. 5a is a front elevational view of the plug-in module of FIG. 4a, illustrating a first exemplary insert configuration.

FIG. 5b is a front elevational view of second embodiment of the plug-in module of the invention, illustrating a second (i.e., two-prong) exemplary insert configuration.

FIG. 5c is a front elevational view of third embodiment of the plug-in module of the invention, illustrating a third (i.e., RJ series connector) exemplary insert configuration.

FIG. 5d is a front elevational view of fourth embodiment of the plug-in module of the invention, illustrating a fourth (i.e., slide switch) exemplary insert configuration of 16-position slide-in connector.

FIG. 5e is a front elevational view of fifth embodiment of the plug-in module of the invention, illustrating a fifth (i.e., DB 9) exemplary insert configuration.

FIG. 5f is a front elevational view of sixth embodiment of the plug-in module of the invention, illustrating a sixth exemplary insert configuration.

FIG. 6a is a bottom elevational view of the plug-in module of the invention, illustrating a first (i.e. grounded duplex) exemplary plug configuration.

FIG. 6b is a bottom elevational view of the plug-in module of the invention, illustrating a second (i.e., inverted grounded duplex) exemplary insert configuration.

FIG. 6c is a bottom elevational view of the plug-in module of the invention, illustrating a third (i.e., inverted two prong) exemplary insert configuration.

FIG. 7a is a top perspective view of an exemplary touch screen module according to the invention.

FIG. 7b is a top perspective exploded view of the module of FIG. 7a, showing the various constituent components thereof.

FIG. 8a is a top perspective view of an exemplary controlled receptacle assembly according to the invention.

FIG. 8b is a top perspective exploded view of the module of FIG. 8a, showing the various constituent components thereof.

FIG. 9a is a top elevational view of a first embodiment of a substantially planar “stickable” conductor bundle, showing a section thereof.

FIG. 9b is a top elevational view of a first embodiment of a substantially planar “universal” corner termination element.

FIG. 9c is a top elevational view of a first embodiment of a modular (e.g., RJ 45) termination element according to the invention.

FIG. 9d is a side elevational view of yet another embodiment of the module of the present invention, adapted for use with the conductor bundle of FIG. 9a.

FIG. 9e is a bottom perspective view of a first embodiment of an adjustable “flex” portrait light fixture according to the present invention, adapted for use with the conductor bundle of FIG. 9a.

FIG. 9f is a side elevational view of a first embodiment of an adjustable light fixture according to the present invention, adapted for use with the conductor bundle of FIG. 9a.

FIGS. 10a-10c are front, side, and bottom plan views, respectively, of an exemplary embodiment of a current transformer bobbin according to the present invention.

FIG. 11 is a functional block diagram of an exemplary embodiment of a networked communications server apparatus adapted for AC power line, network and telephony control.

FIG. 12 is a functional block diagram of an exemplary network configuration utilizing the communications server apparatus of FIG. 11.

FIG. 13a is a functional block diagram of an exemplary power-over-Ethernet (PoE) configuration according to the present invention.

FIG. 13b is a schematic diagram of an exemplary Ethernet-powered network device according to the present invention.

FIG. 13c is a functional block diagram of an exemplary multi-port PoE Ethernet switch according to the present invention.

FIG. 13d is a schematic diagram of an exemplary multi-port controller circuit according to the present invention.

FIG. 13e is a functional block diagram of an exemplary powerline module providing one or more “derived” Ethernet ports.

FIG. 14a is a schematic diagram of an exemplary fluorescent dimmer control circuit (with waveform modification) according to the present invention.

FIGS. 14b and 14c illustrate exemplary waveforms associated with the circuit of FIG. 14a for inductive ballast and electronic ballast applications, respectively.

FIG. 15 is a schematic diagram illustrating an exemplary blocking filter circuit useful with the present invention.

FIG. 16a is a schematic diagram illustrating an exemplary user-installable thermostat controller circuit useful with the present invention.

FIG. 16b is a composite elevational view and functional block diagram of a first exemplary embodiment of user-installable ventilation module according to the present invention.

FIG. 16c is a composite elevational view and functional block diagram of a second exemplary embodiment of user-installable ventilation module of the invention.

FIGS. 17a and 17b are front perspective and functional block diagrams, respectively, of an exemplary embodiment of a portable remote device used for controlling various aspects of the automation system of the present invention.

FIG. 18a is a piping diagram of an exemplary embodiment of a user-installable hot water recirculation system according to the invention.

FIG. 18b is a block diagram of an exemplary embodiment of a powerline-based user-installable water leakage detection system according to the invention.

FIG. 18c is a block diagram of an exemplary embodiment of a powerline-based user-installable water pressure sensing and isolation system according to the invention.

FIG. 19 is a block diagram of an exemplary embodiment of a powerline-based user-installable door and window position sensing system according to the invention.

### DETAILED DESCRIPTION OF THE PREFERRED EMBODIMENT

Reference is now made to the drawings wherein like numerals refer to like parts throughout.

As used herein, the terms “stickable⇄, “sticky”, “adhesive”, and the like refer to permanent, semi-permanent, or non-permanent mounting or bonding technologies including, without limitation, tapes, liquid adhesives, adhesive coatings or layers, epoxies, so-called “super glues” (e.g., methacrylates), and so forth. An exemplary semi-permanent adhesive system is manufactured by the 3M Corporation, wherein the user may release the “command” adhesive from the surface to which it is bonded using a downward or lateral force on a portion of the adhesive layer.

As used herein, the term “signal conditioning” or “conditioning” shall be understood to include, but not be limited to, signal voltage transformation, filtering and noise mitigation or elimination, current limiting, sampling, signal processing, and time delay.

As used herein, the term “integrated circuit” shall include any type of integrated device of any function, whether single or multiple die, or small or large scale of integration, and irrespective of process or base materials (including, without limitation Si, SiGe, CMOS and GAs) including without limitation applications specific integrated circuits (ASICs), field programmable gate arrays (FPGAs), digital processors (e.g., DSPs, CISC microprocessors, or RISC processors), so-called “system-on-a-chip” (SoC) devices, memory (e.g., DRAM, SRAM, flash memory, ROM), mixed-signal devices, and analog ICs.

The term “processor” is meant to include any integrated circuit or other electronic device (or collection of devices) capable of performing an operation on at least one instruction including, without limitation, reduced instruction set core (RISC) processors, CISC microprocessors, microcontroller units (MCUs), CISC-based central processing units (CPUs), and digital signal processors (DSPs). The hardware of such devices may be integrated onto a single substrate (e.g., silicon “die”), or distributed among two or more substrates. Furthermore, various functional aspects of the processor may be implemented solely as software or firmware associated with the processor.

As used herein, the term “application” refers generally to a unit of executable software that implements theme-based functionality The themes of applications vary broadly across any number of disciplines and functions (such as e-commerce transactions, brokerage transactions, mortgage interest calculation, home entertainment, calculator etc.), and one application may have more than one theme. The unit of executable software generally runs in a predetermined environment; for example, the unit could comprise a downloadable Java Xlet™ that runs within the Java™ environment.

As used herein, the term “computer program” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ (including J2ME, Java Beans, etc.) and the like.

As used herein, the terms “network” and “bearer network” refer generally to any type of telecommunications or data network including, without limitation, data networks (including MANs, WANs, LANs, WLANs, internets, and intranets), hybrid fiber coax (HFC) networks, satellite networks, and telco networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “wireless” includes, but is not limited to, IS-95, CDMA2000, Wideband CDMA (WCDMA), Bluetooth™, IrDA interface, IEEE Std. 802.11 (a) or (g), Wireless Application Protocol (WAP), GPRS, GSM, TDMA (e.g., IS-54 or 136), UMTS, third-generation or “3G” systems such as 3GPP and 3GPP2, ultrawideband (UWB) systems such as TM-UWB or 802.15, WiMAX, satellite systems, or any other of myriad data communication systems and protocols well known to those of skill in the communications arts.

As used herein, the term “digital subscriber line” (or “DSL”) shall mean any form of DSL configuration or service, whether symmetric or otherwise, including without limitation so-called “G.lite” ADSL (e.g., compliant with ITU G.992.2), RADSL: (rate adaptive DSL), VDSL (very high bit rate DSL), SDSL (symmetric DSL), SHDSL or super-high bit-rate DSL, also known as G.shdsl (e.g., compliant with ITU Recommendation G.991.2, approved by the ITU-T February 2001), HDSL: (high data rate DSL), HDSL2: (2nd generation HDSL), and IDSL (integrated services digital network DSL), as well as In-Premises Phoneline Networks (e.g., HPN).

As used herein, the terms “client device” and “end user device” include, but are not limited to, personal computers (PCs) and minicomputers, whether desktop, laptop, or otherwise, set-top boxes, personal digital assistants (PDAs) such as the Apple Newton®, “Palm®” family of devices, handheld computers such as the Hitachi “VisionPlate”, personal communicators such as the Motorola Accompli devices, J2ME equipped devices, cellular telephones, or literally any other device capable of interchanging data with a network.

Additionally, the terms “site”, “premises” and “structure” as used herein shall include any location (or group of locations) having one or more functions capable of using one or more aspects of the present invention including, without limitation, residential houses, apartments, trailers, watercraft (e.g., “houseboats”), motor homes, offices, and businesses.

As used herein, the term “extension device” is meant to include any type of telecommunications device compatible with use on existing telecommunications lines, including without limitation conventional telephones, answering machines, facsimile machines, wireless or satellite receivers, and multi-line phones.

As used herein, the term “display” means any type of device adapted to display information, including without limitation LCDs, TFTs, plasma displays, LEDs, CRTs, FEDs, and fluorescent devices.

As used herein, the term “controller” generally refers to an apparatus or algorithm providing one or multiple control functions to itself or another device. Examples of controllers include servers, schedulers, microcontrollers, PID controllers, and so forth.

As used herein, the term “powerline” refers to any technology which is used to transfer data or signals over a power distribution system, including without limitation UPB, HomePlug, HomePlug a/v, and X-10 technologies.

As used herein, the term “UPB” or Universal Powerline Bus refers generally to technologies which impose digital or analog signals or pulses onto AC waveforms or DC power delivery systems, such as for example the well known UPB industry standard approach. set forth in “Universal Powerline Bus: The UPB System Description”, Version 1.1 dated Sep. 19, 2003, incorporated herein by reference in its entirety.

Lastly, the term “homeplug” as used herein is meant specifically to include devices and systems compliant with the HomePlug™ Powerline Alliance Specification for powerline-based home networks (including the more recent HomePlug A/V), and generally to include all other comparable devices adapted for powerline networking.

Overview

The present invention seeks to improve and simplify the premises (e.g. home) automation process through a variety of advantageous design features, including: (i) integrating most of the functions within a compact, unitary multi-function controller (e.g., server); (ii) reducing the complexity and cost of installation of the technology through modular and user(self)-installable components, and use of existing structure wiring (e.g., electrical power wiring, telecommunications, and cable television system wiring) to the maximum extent practicable; and (iii) providing a high level of system scalability so that each particular installation can be readily configured to meet the customer's needs at the lowest cost and with the least complexity, while also simultaneously permitting expansion to cover literally every type of function relating to the structure including, e.g., HVAC/environmental control, security, entertainment, energy conservation and management, and safety.

The present invention provides apparatus and methods for achieving these goals. It is advantageously made extremely simple to install and use, thereby providing greater accessibility across a wide stratum of different users. Also, very minimal changes to the user's premises are required, thereby effectively removing any disincentive in this regard; e.g., where a renter, lessee or homeowner wants a fully reversible and removable installation.

The present invention is also made quite comprehensive; i.e., it addresses a wide range of potential automation applications and issues that may be encountered by the user or homeowner, thereby obviating the need of such persons to piece together a mixed or heterogeneous system (e.g., from multiple vendors) as in the prior art. The present invention (with proper additions by the user) addresses the whole spectrum of automation needs, including water leak detection, isolation and conservation, heat or fire detection and extinguishing, alarm/notification, security functions including remote monitoring, energy conservation, multimedia delivery, computer networking and distribution, lighting control, and a plethora of other such applications.

Automation System

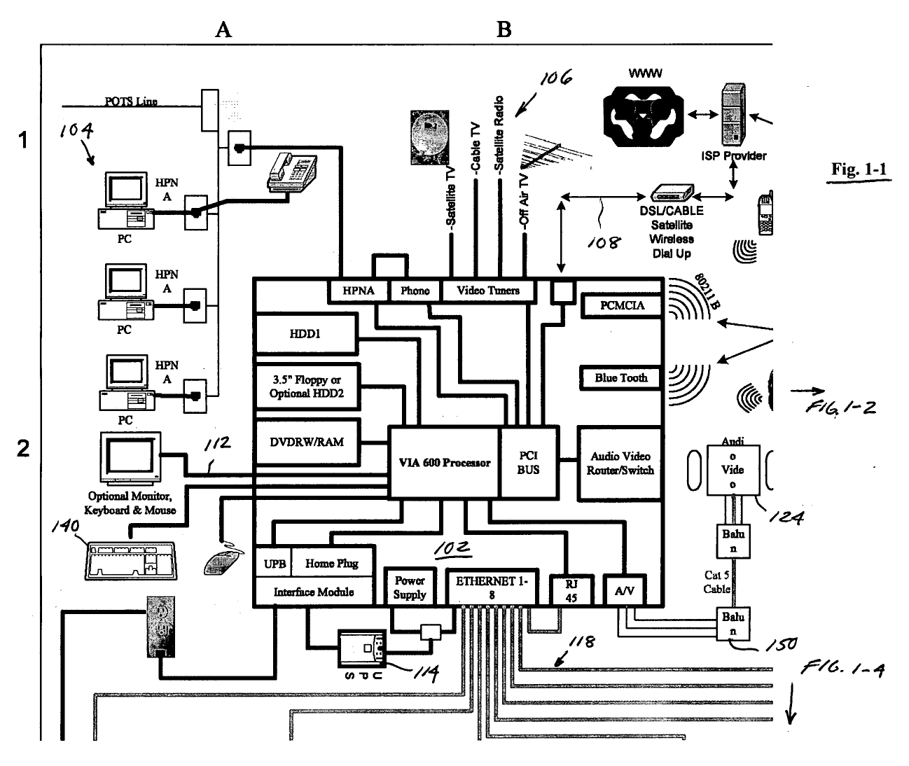

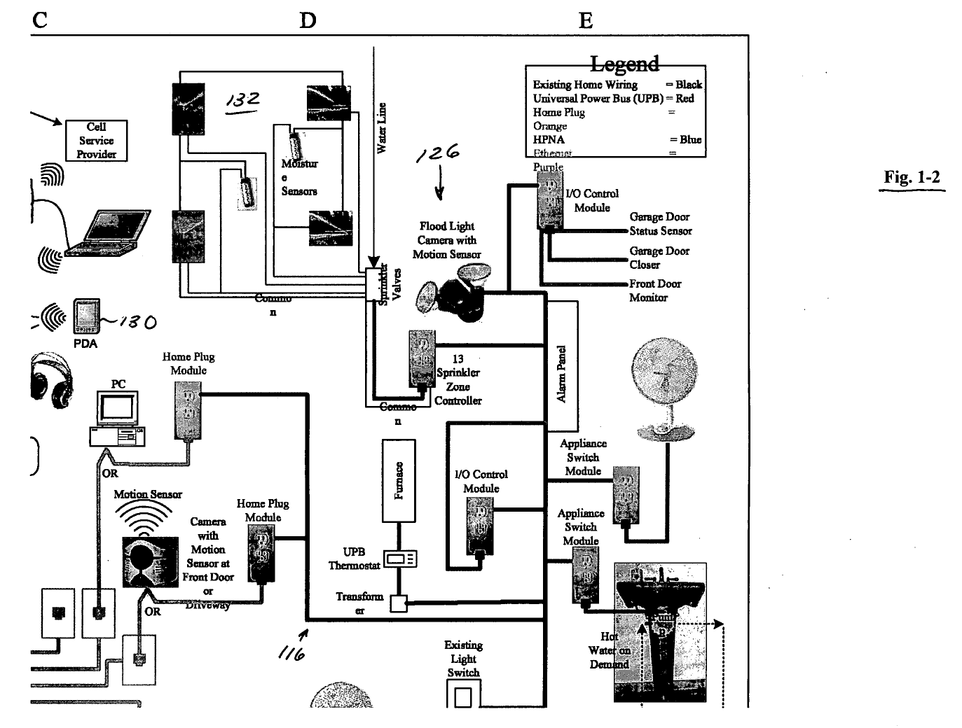

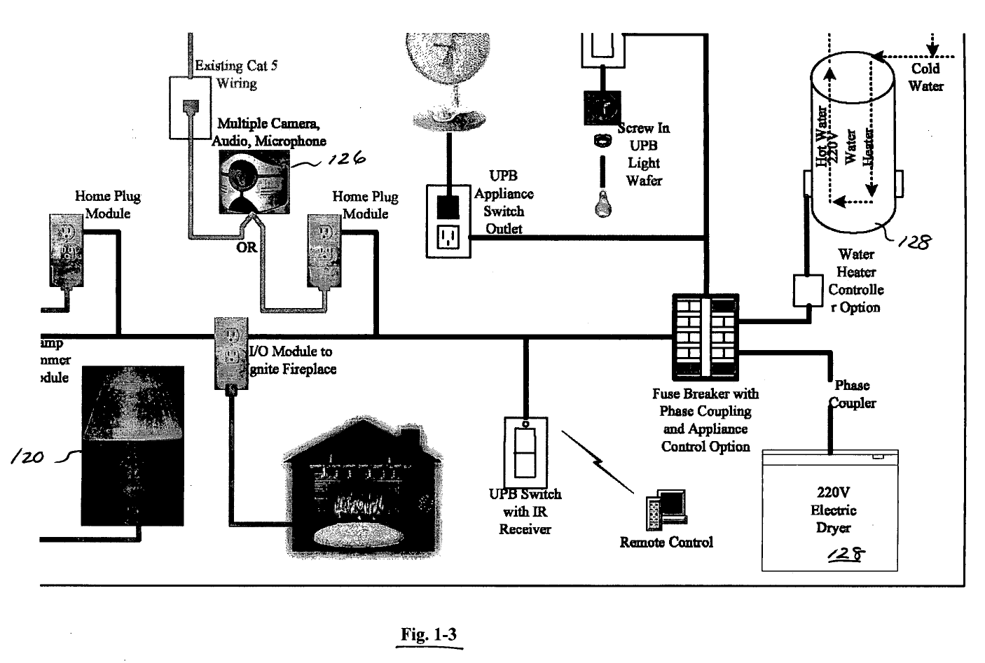

Referring now to FIG. 1, a first exemplary embodiment of a substantially automated system 100 utilizing various facets of the present invention is described in detail.

It will be recognized that while one aspect of the present invention comprises an integrated and coordinated system of the type represented by the exemplar of FIG. 1, the various aspects of the invention may be employed either alone or in combination with one or more other aspects of the invention to achieve the desired result. Hence, advantageously, the invention is inherently modular and completely scalable. More or less components of a particular type can be used, as well as more or less types of different components.

It will further be recognized that while the terms “home” and “consumer” may be used herein in association with one or more aspects and exemplary embodiments of the invention, the invention is in no way limited to such applications. The various aspects of the present invention may be applied with equal success in, inter alia, small or large business (e.g., so-called “enterprise” systems), industrial, and even military applications if desired.

It is noted that while portions of the following description is cast in terms of RJ-type connectors and associated modular plugs of the type well known in the telecommunications art, the present invention may be used in conjunction with any number of different connector types. Accordingly, the following discussion is merely exemplary of the broader concepts.

As previously discussed, the present invention seeks to improve and simplify the (e.g. home) automation process through a variety of advantageous design features, including: (i) integrating most of the functions within a compact, unitary server (or alternatively scheduler or controller); (ii) reducing the complexity and cost of installation of the technology through modular and self-installable components, and use of existing structure wiring to the maximum extent practicable; and (iii) providing a high level of system scalability so that each particular installation can be readily configured to meet the customer's needs at the lowest cost and with the least complexity, while also simultaneously permitting expansion to cover literally every type of function relating to the structure including, e.g., HVAC/environmental control, security, entertainment, energy conservation and management, and safety. These various aspects are now described in detail with reference to FIG. 1.

As shown in FIG. 1, the exemplary system 100 generally comprises a plurality of components, including inter alia: (i) a server device 102, a plurality of HPN (home phone network) devices 104, various content channel feeds 106, a DSL/ADSL network interface 108, one or more wireless hubs 110, a control interface 112, a uninterruptable power supply (UPS) 114, a low-frequency AC power supply network (e.g., HomePlug or comparable powerline system) system 116, and a data (e.g., 802.3 Ethernet) network 118. As will be described in greater detail below, these components interact with the server 102 (and each other to varying degrees) in order to effectuate the desired control of the various devices within the structure, including lighting 120, telephony 122, video, systems 124, security cameras 126, appliances 128 (including, e.g., water heater/water-on-demand system, dryer, oven, fan, HVAC, etc.), personal/home electronics 130, and sprinkler systems 132. All of the electrical items that are powered can generally be controlled to some extent, to include literally any type of electronic or electromechanical devices capable of receiving control inputs.

It is noted that in the present context, the term “control” may be as simple as control of signals and/or power applied to a device (i.e. turning AC or DC power to the device on or off), or as complex as processor/microcontroller-based, algorithmically controlled, multivariate operation. Myriad other types of control schemes are possible consistent with the invention. “Control” may also include the prevention of one or more occurrences. Hence, the term “control” shall be construed broadly in the present context.

For improved entertainment and media value, the system 100 can also be configured to store and distribute audio and video media and applications (whether as discrete files, or streamed content) as well as accept TV antenna, CATV/HDTV, Satellite RF signal input (via the content interface 106), and even streamed Internet content. Downloads from DVDs, CDs, digital cameras, digital video camera, and other client devices can also be stored on the server 102 (or other associated storage device either on or off-premises, such as a RAID or comparable mass storage device, or dedicated Internet-based storage system) for later distribution to any monitor, computer, or network node in the house, including wireless distribution points. Indigenous audio, video, and sensor data can also be delivered directly and/or stored for later delivery, streaming, or playback. The server 102 may be integrated with other media functions also, such as by being co-located or including a DSTB, satellite receiver, etc. These devices may also utilize the modular form factors described subsequently herein.

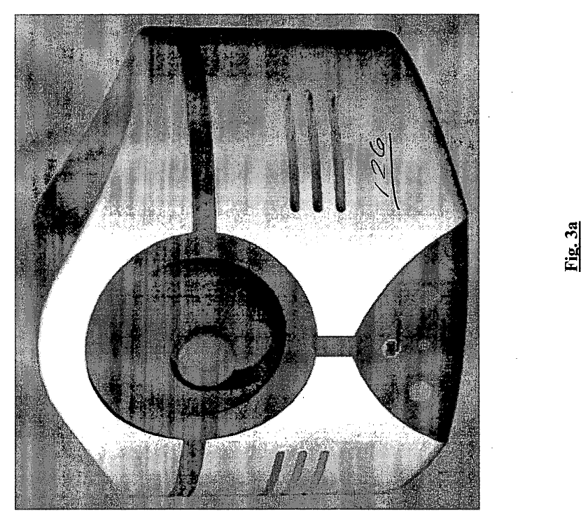

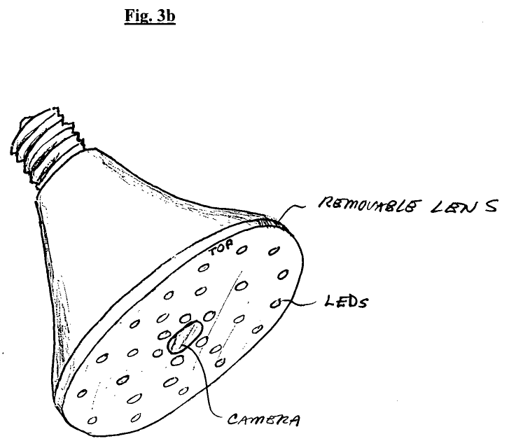

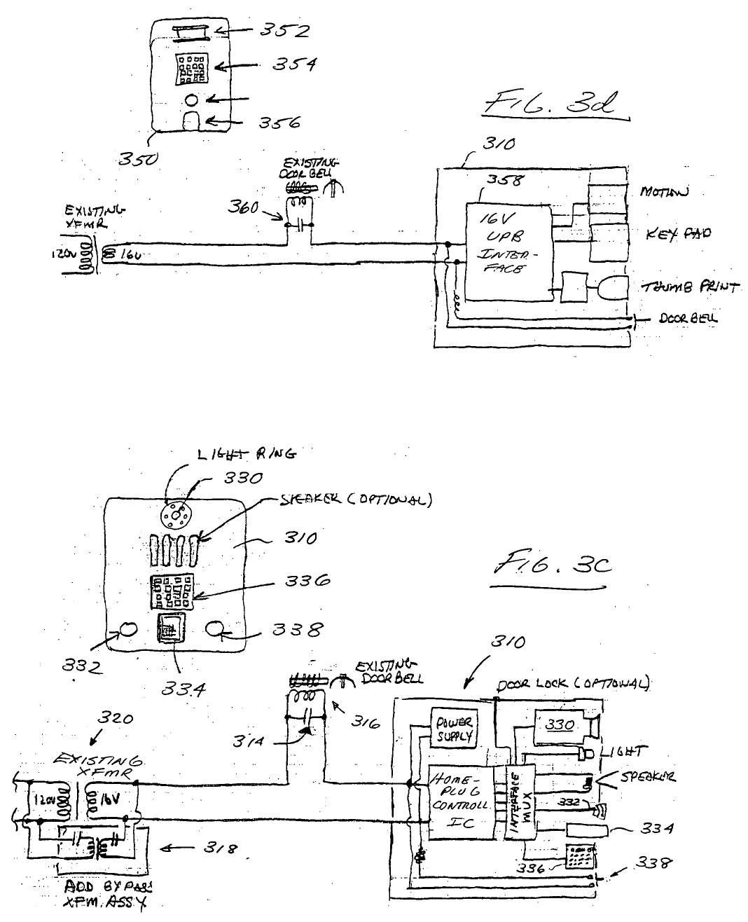

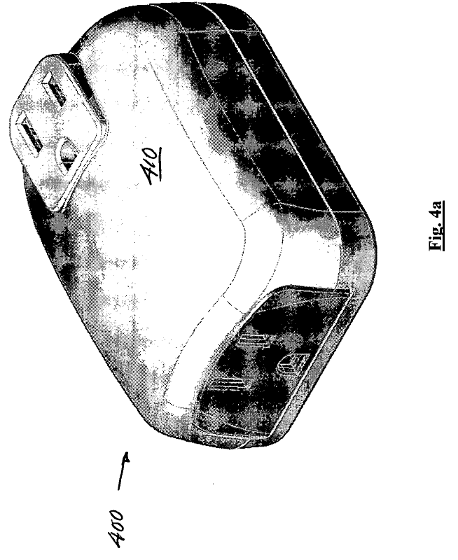

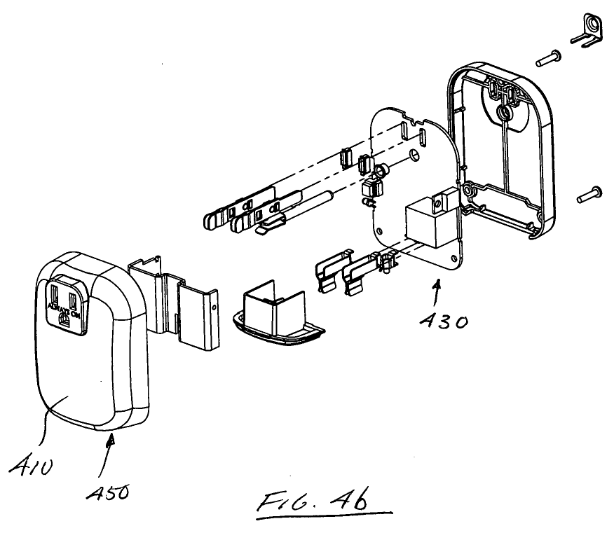

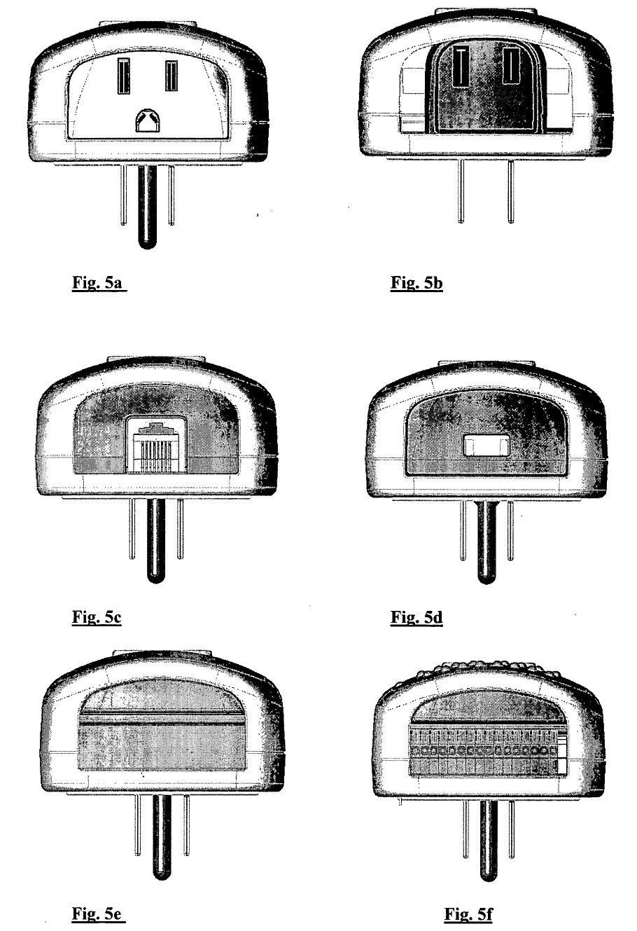

It will be appreciated that while the illustrated embodiment 100 of FIG. 1 is cast at least partly in terms of “wired” systems such as the indigenous AC power wiring and other cable interfaces, much of the functionality described herein can be accomplished using well known wireless interface technology. The various wired approaches described below, however, have the advantages of ultra-low cost and simplicity of installation (and operation) as well as reliability, although wireless systems and interfaces are becoming much more ubiquitous. For example, in one variant of the present invention, the local control modules (e.g., those modules 410 such as shown in FIG. 4a or 5a-f in connection with the premises electrical wiring) are configured with short-range wireless interfaces such as e.g., those compliant with the Bluetooth or IrDA specifications, thereby obviating a direct wiring run from the module 410 to the local control device or sensor. This approach adds significant flexibility, yet increases the cost of the modules 410 (and also the controlled components).

Furthermore, while certain embodiments are described in terms of an exemplary UPB or HomePlug protocols, the use of a particular protocol within a particular device is completely flexible, and other such protocols or technologies can be substituted.

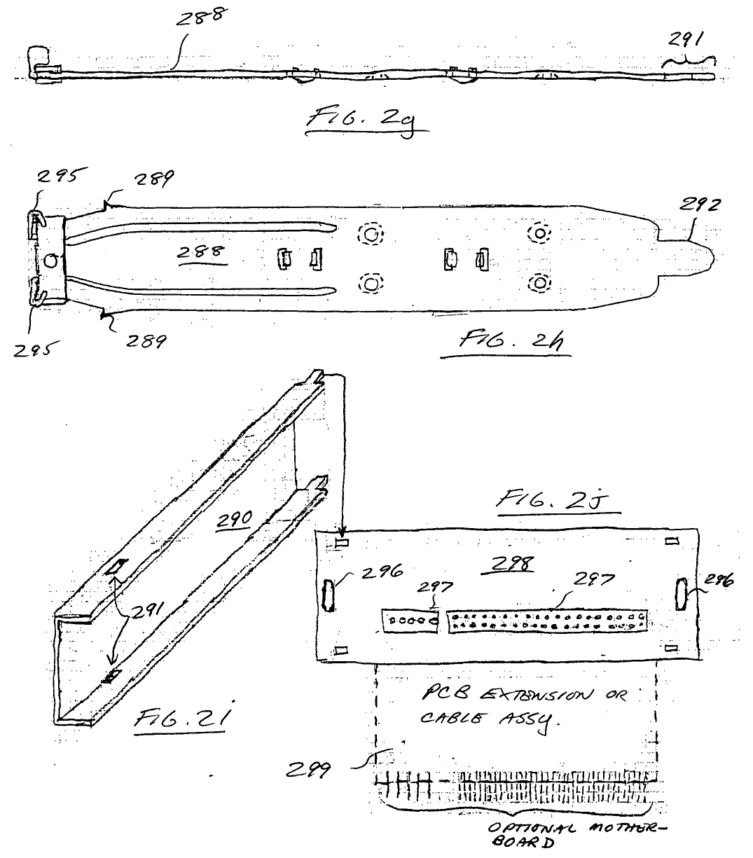

In terms of security, one or more cameras 126 are located around the site in order to provide monitoring. As used herein, the term “camera” may include not only visual band (optical) cameras, but also non-visual band (e.g., IR or millimeter wave) devices, and also may include CCD or CMOS based devices. For example, in the front porch area of a house, screw-in flood lights and outside cameras with motion detection for event recording (see, e.g., the exemplars of FIGS. 3a and 3b) are coupled to the system, thereby making their data viewable on any monitor within the structure (or a remote monitoring site such as a security monitoring facility, or even a client device) with Internet or other network access. An upstream (OOB) DOCSIS channel of the CATV system may also be used for this purpose. In one exemplary configuration, hand-held client devices (including cell phones with video/picture reception capability, such as the Sprint “Vision” technology) are utilized in conjunction with the system to provide such remote viewing.

Additionally, door and window locks (and position or other associated sensors such as electrical or optical/IR continuity) can be controlled as part of the security features of the system. Optionally, a front door thumbprint and/or voice recognition system of the type well known in the security arts may be coupled to the system 100 so as to control premises entry or access (and even control of the system 100 itself).

For improved safety, one or more of the cameras of the system 100 include smoke, heat and/or (natural) gas detectors, emergency lights and/or alarm speakers for broadcasting audible and visual alarms throughout the house. Alerts may also be distributed via the various monitors, TVs, wall plate LCDs, and cellular phones or other connected devices. Such alerts may include very basic “binary” information (e.g., alert or no alert, etc.), and/or more sophisticated content such as the location of the fire or gas leak, the location (sensor) where motion has been detected, levels of HC, CO or other toxic substances, etc.) The various system alarms can also be configured to be adaptive; e.g., to change volume and tones according to either a predetermined pattern (such as a repetitive, sweeping increase in both volume and frequency, or a simultaneous broadband acoustic emission), or deterministically based on one or more input criteria (such as continued detected IR signature within the structure) to ensure it can be seen and/or heard by everyone.

The system 100 also provides significant benefits in terms of managing water uses (such as sprinklers, hot water heating, etc.). The system 100 saves water by not sprinkling when it is not needed. The server 102 is optionally programmed to know the season, and adjust the watering times, but also monitor the actual moisture in the ground by adding sensors to the front, rear, and sides of the house and adjust the sprinkler times and/or days. Such adjustment may be “dumb”, e.g., every day, every other day, every third day, etc., or “smart” (e.g., based on data input from the moisture sensors, rain level sensor, ambient temperature profile, moisture depth within the soil, etc.). The sprinkler controller can readily be added to replace an existing controller by simply transferring the existing controller leads to the present controller. The moisture sensors are simply added near the appropriate sprinkler valves or other relevant locations, and connected at the valve wires; hence, there are no new wires to run, so installation can be readily performed by the user. A rain gauge can also be connected to the controller to modify the watering schedule, and a water pressure sensor can be added (described below) to sense the presence of a defective leaking sprinkler head or other system rupture.

FIG. 5f illustrates an exemplary configuration of a sprinkler controller with moisture sensors, which is illustrative of the broader principles of the invention. A moisture sensor control integrated in the controller allows for driving the sprinkler system valves, and monitoring the sensors over the same wires; this approach allows for a simple self-install by the user. In one exemplary application, the sensor is located within 6 ft from the valve, and the interface module installed. This installation puts a capacitor in-series with the solenoid to block the DC, and a resistor in-series with the moisture sensor and a capacitor across the sensor to block the AC from the sensor. To operate the valve, the controller applies AC which is coupled by the series capacitor, and the AC is blocked by the series resistance and the shunt capacitance blocks the AC from the sensor. To sense the sensor, the controller sends a DC voltage to sense the DC current in the sensor, which indicates the moisture in the ground or other location being monitored.

The system can also be used for preventive isolation and/or leak detection, such as where an isolation valve is automatically activated to close at (i) a preset time of day, such as where the owner departs for work, or (ii) upon occurrence of one or more conditions within the structure, such as significant decrease in hydrostatic water pressure or increase in flow rate within the structure's plumbing system when no “authorized” use such as operation of the dishwasher, is in progress. Many residential sprinkler systems, for example, commonly “blow” sprinkler heads, thereby dramatically increasing system flow rate and water consumption, and reducing pressure to other parts of the system. This is extremely wasteful, and can be mitigated using the present system 100, specifically through selective isolation of the water supply or particular parts of the sprinkler system (e.g., where multiple pressure sensors and/or flow arte sensors are used in various portions of the system). Sprinkler moisture (e.g., conductivity) sensors may also be used to avoid over-watering, and detection of breakage or sprinkler head loss (or even rupture of hot water heater elements or piping within the structure).

A hot water recirculator (see FIG. 1, Zone E3) traditionally uses a pump and a third pipe to circulate hot water from the hot water tank to the farthest end of the home. One exemplary embodiment of the present invention advantageously does not require a third pipe; instead the water pump is located at the farthest device (e.g., sink) and pumps water from the hot water faucet pipe through the cold water line back to the hot water tank bottom, and pumps only until the hot water arrives at the sink and is stopped from the hot water temperature sensor. To install, the pump is equipped with fittings and hoses to connect across the hot to cold hose connections with a one-way (check) valve. The pump/temperature cord is plugged into the controller, which is plugged into a standard 115 VAC receptacle above the sink. The cord needs to be routed from under the sink to above the sink, which can be readily accomplished with a ¼′ drill or some other method. Optionally, a lighted button on the controller can also indicate that the hot water is present (e.g., the light changes color from yellow to red when the water reaches the prescribed temperature). Other schemes for indication of temperature may also be used consistent with the invention.

Additionally, reduced water usage may be provided through selective use of other “on demand” hot water delivery techniques which mitigates “running the tap” until the heated water emanates from the tap. This feature can be provided by, inter alia, (i) use of a small, selectively preheated surge volume, (iii) by motion sensing (e.g., sensing when the structure is occupied and activating heating or pre-heating), (iv) via a timer, or (v) any other comparable approach or combination of the foregoing.

Energy consumption within the monitored premises can be reduced by measuring usage, and managing when certain appliances are used such that the most favorable rates are applied. For example, if differential kwh rates are in place as a function of time of day, or if rolling blackouts are imminent, high-consumption activities (such as electric clothes dryer operation) can be automatically deferred until lower rates are in effect. Additionally, auto-shutoff of room lights, and use of power-sense technology on units supplying power to enlighten the home resident on power usage on the particular appliances, may also be employed.

For example, the system can be used to automatically shut off lights or HVAC when not needed. Outside lighting control can automatically track dusk, and lighting can be switched on or off at an easily changed preset time. Additionally, the exemplary embodiment of the invention utilizes one or more UPB controlled circuit breakers. With built-in control (UPB), these breakers can reduce utility rates by reducing the peak demand by switching off electricity to the electric water heater, spa, dishwasher, electric dryer, etc. at peak hours. Eventually, it is expected that your electricity rate may be based on the peak demand compared to average power, so the server can prevent you from exceeding this demand.

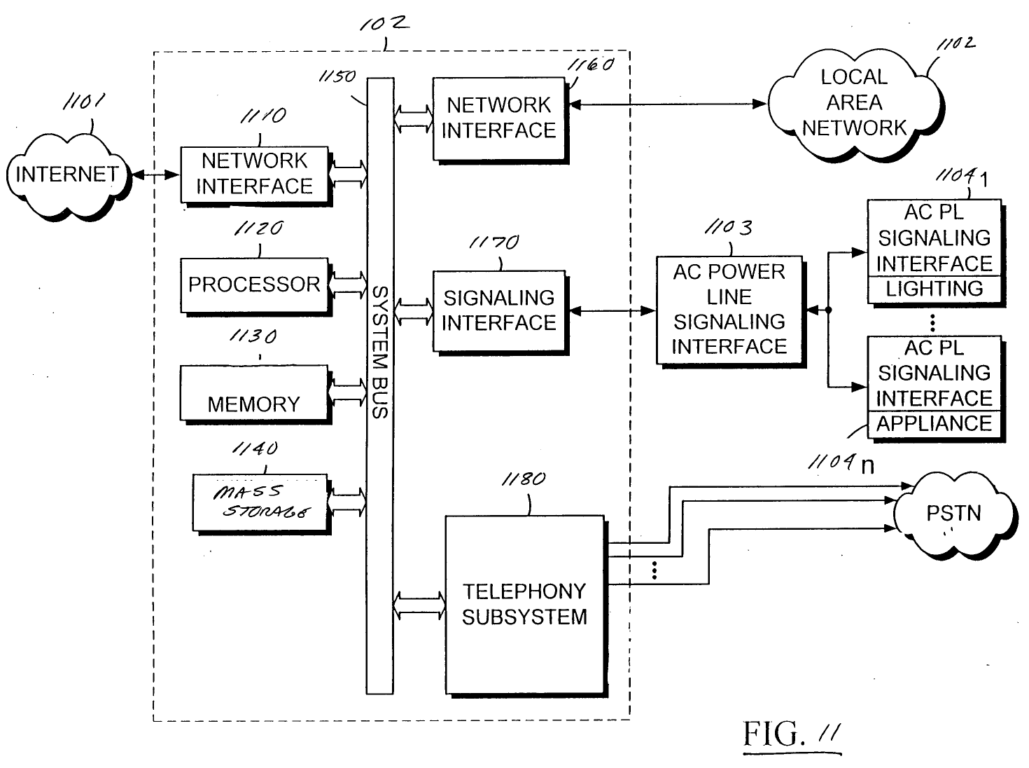

Furthermore, lost or spoiled foods can be eliminated by providing a means to measure and track refrigerator or freezer temperatures and maintain them at optimal values (from both food preservation and energy consumption perspectives). For example, temperature sensors may be added (e.g., using sticky-back tape wire of the type described herein with respect to FIG. 10) in refrigerators and freezers to sense when the temperature rises, and take appropriate corrective action (either via the refrigerator or freezer's indigenous systems, or via control of the immediate external or ambient environment, or other relevant parameter).

In another feature of the invention, any of the power-controlled UPB modules of the system 100 can measure the power consumption in any device (e.g., refrigerator, freezer, TV, etc.) and the server 102 can be used to calculate the cost per day or monthly cost for that device (including use of tiered or differential energy rates), thereby encouraging the home owner to initiate further power savings. An improved current transformer bobbin that allows implementation of a very low cost current sense transformer is also described subsequently herein with respect to FIG. 10.

The exemplary system 100 also provides for HVAC and furnace control. In one embodiment, a self-install thermostat is inserted in place of existing thermostat using existing wiring, with communications over the existing wiring and through the 24V transformer using the aforementioned UPB technology. Software in the server 102 monitors ambient temperature around the house (i.e., form one or more zones) and adjusts the furnace or other HVAC device to the home owner's comfort. The server 102 can select which temperature sensor(s) will be used to control each part of the house based on one or more criteria such as, e.g., time of day, as specified by the owners desires. This feature helps prevent “skewing” of the ambient temperature within the house due to various effects such as direct solar radiation on the thermostat, which artificially elevates the detected ambient temperature, etc.

An optional universal self-install register enhancer with fan/damper can be installed over a temperature-troubled room register to either enhance or impede the air flow to better equalize the room's temperature to match the home owners' desired temperature. In one embodiment, the enhancer device is substantially modular and is simply mounted to the top of the existing register, and the cord plugged into the closest power outlet. Optional low voltage sticky-back tape wiring (described subsequently herein) can be used to connect to a low voltage register unit for a more aesthetic semi-permanent self-install. The register enhancer also has a temperature sensor to communicate temperature data to the server 102, and/or to self-regulate the flow to that room.

Furthermore, the aforementioned register enhancer devices (as well as the system 100 as a whole) can be used to enhance HVAC savings by enhancing or retarding air flow to various rooms that are desired, and/or blocking rooms that are unoccupied. Small motor drives can also be outfitted to window shades mechanism and/or doors to such spaces, further enhancing efficiency.

The server 102 of the illustrated embodiment is configured as a permanent fixture, although non-permanent approaches may be used as well. The presence of the system 100 and server 102 may add significantly to the value of the home when the latter is sold. Alternatively, the server 102 can be made removable (such as removable theft-proof automobile radios) such that a new owner can simply insert a server unit of their own desired configuration. The modularity of the server 102 and its components allows for a degree of custom configuration, as well as retention of settings and user-specific information.

Furthermore, various settings or data stored within the server 102 can be made specific to individual family members and their personal devices. For example, where one family member desires a certain operational profile which is different from that of another, such profile can be readily recalled and implemented, somewhat akin to recalled settings for the drivers seat position of an automobile, as is well known in the control arts.

While the illustrated server 102 is not a “family PC” per se, it can network the PCs or other client devices within the premises. For the home owner that does not have a PC, the server 102 can be configured using appropriate software applications and a protocol stack for e-mail, and web browsing, and other comparable functions either from a direct monitor and mouse/keyboard 140 via the control interface 112, via a remote (wireless) client device interface (such as a hand-held, PDA or laptop computer, or WAP/3G enabled device, etc.).

The exemplary server 102 can be optionally configured to provide a variety of software features and functions, including acting as a native address translation (NAT) router for sharing one high speed (e.g., DOCSIS or DSL) Internet access connection with multiple nodes on a residential local area network. such as the Ethernet, home phone network (HPN), wireless, and/or HomePlug (HP) networks of FIG. 1.

The server 102 may also include firewall capability of the type well known in the data security arts, for protecting internal assets from being “hacked” by third parties outside the server wall. Similarly, virtual private network (VPN) and even RADIUS server capability can be provided, wherein users within the premises LAN can tunnel encapsulated IP or other protocol packets across the Internet or other external network. to maintain security.

The server 102 also provides administrator functions such as setting up users and passwords, shutting down the system 100 (or parts thereof) for maintenance, backing up system configurations and files, diagnostics, and performance evaluations. A common user interface is also optionally provided to control all web-enabled devices within the premises from one location (or via one network access point).

The server may also be configured with a variety of ancillary features, such as without limitation (i) “pop-up” blockers, (ii) Windows® XP Messenger attack blockers, (iii) anti-virus software, (iv) SPAM filters, (v) useage monitors (e.g., the ability to monitor where all users on the residential LAN have been surfing), (vi) parental control functionality with the ability to block an individual device from surfing on the web, or to only allow that PC to surf certain websites and/or times. The server 102 can also act as an email server, and allow individual control of user e-mail, including the ability to block all attachments, or just certain attachments.

The server 102 may incorporate an intranet and a database entity which allows for network applications, such as an address book or calendar, which can be shared among all users on the local network (or even external users if desired, such as where the database can be accessed by a remote client device). The server 102 may also incorporate File Server features, allowing for file storage for backup of critical files, and collections of digital music, photos, or other media to be distributed among users.

Furthermore, the server may be configured to allow viewing of images from internal or external network IP or similar cameras (e.g., “webcams”) on a common user interface, such as via an ITU-H.323/H.245 protocol stack of the type well known in the computer arts. VoIP stacks may also be utilized to allow for IP-based voice communications within the premises LAN or between one or more nodes of the LAN and an external entity.

The server 102 can also be configured to act as a backup server to allow users to back up critical files on the server; e.g., via a network attached storage unit (NAS) or SCSI/IDE/1394 RAID device. Video or streamed content can also be stored in conjunction with a DSTB (such as the Scientific Atlanta 8xxx Series STBs), such as where the DSTB IEEE-1394 interface is employed to use the server 102 as a remote or secondary video storage device for later recall or playback.

The server 102 also permits the control of lights and appliances either manually, remotely, by time of day, by triggering from another device, or other such schemes well known in the art. Grouping of multiple commands into “macros” or unified commands is also optionally provided such that one action (e.g., push of a button, selection of a function on a touch screen, etc.) will cause multiple events to occur, thereby further simplifying operation of the systems 100.

As referenced above, the exemplary system 100 of FIG. 1 may use a variety of different distribution technologies, including: (i) low speed power line control, over the house wiring, using universal power line bus (UPB) designed by power line control systems (PCS); (ii) broadband transmission of audio/video or other content over power lines using HomePlug (HP), and later HomePlug audio/video (HP a/v); (iii) home phone network (HPN) over the house telephone wires for broadband home networking between computers with in the house and to the IP equipment; (iv) 802.11b/g wireless for connecting to notebook computers, PDAs, or other client devices for mobility around the premises; (v) pre- or post wired CAT-5/6 wiring for Ethernet and/or a/v using a/v baluns 150; (vi) coaxial cable distribution for RF/video/satellite/off-air applications; and (vii). Bluetooth wireless for, e.g., telephone or music headset and other short-range applications.

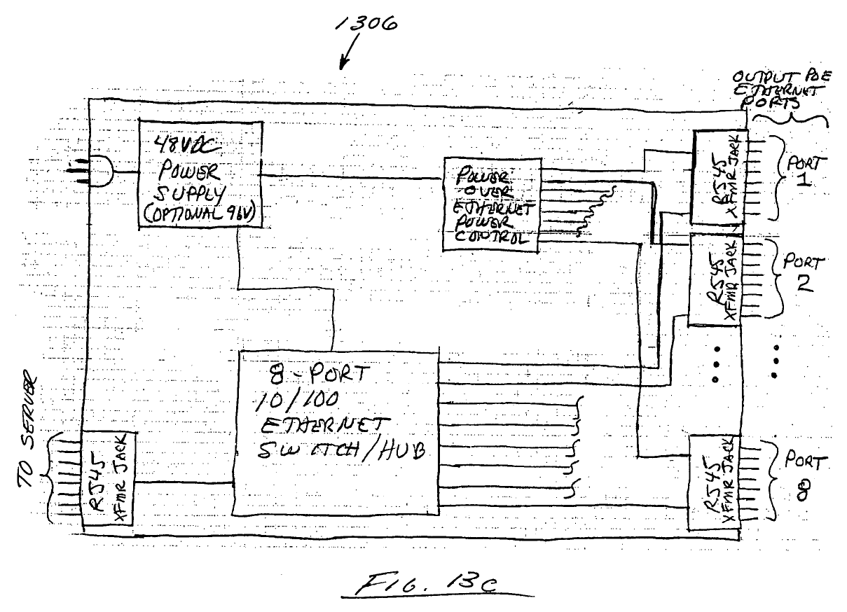

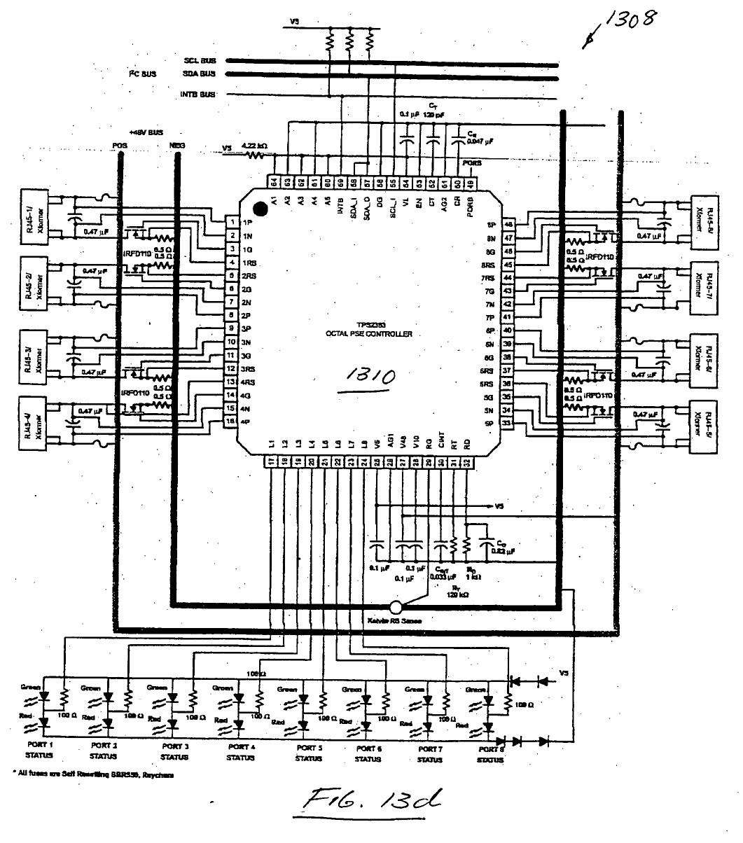

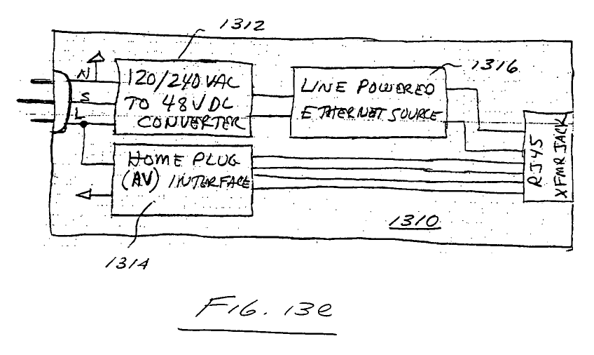

As previously discussed, the system 100 integrates several key features, including extremely low cost of installation and maintenance, comprehensive integration of all automation aspects for the premises, and inherent flexibility. Since the server 102 is compatible with several broadband transport modalities available for distribution of a/v/information or data, the customer can pick the one that best fits his or her particular situation. For example, if the premises is already equipped with CAT-5/6 cabling, Ethernet-based components can be used to interconnect the various sources and users of broadband information. Alternatively, where no CAT-5/6 or comparable cable exists, an HP network-to-Ethernet adapter can be used to interconnect the devices (see discussion of FIG. 13e below). This feature is especially useful for Ethernet IP phones or IP cameras, or the control (6″/10″) touch monitor or wall-hanging type TV monitor or speaker drivers.

The present invention also provides exceptional scalability; the system is scalable from a small inexpensive “low-end” configuration having a limited number of control modules and features, to a larger high-end system with multi-room a/v entertainment systems and other such features. Hence, the system 100 is also advantageously user-configurable as well as scalable. That is, the user can self-upgrade or alter the capabilities and/or configuration of their system by simply adding or plugging in modules to the server 102 (or the remote units in the various rooms of the premises).

Advantageously, the exemplary system 100 is also self-repairable; the customer does not have to hire a costly technician to repair the system. Rather, the server 102 is configured to automatically detect the defective unit(s) or software using its self-diagnostic features. In one business model, replacement modules and components (including software upgrades) are made available from, inter alia, the manufacturer's Internet web site. The server 102 and system 100 as a whole is specifically adapted such that the customer can replace all defective modules. Specifically, with respect to the server, each module is connectorized, and simply slides out of the server 102. Optionally, the server 102 can also be placed in data communication with a remote service entity which can, run diagnostics (either periodically, or upon occurrence of one or more events or request from the customer) and diagnose failures in the system, thereby assisting the customer in his program needs. Such services can be provided free-of-charge, on a per-use pay basis, or via subscription, although other paradigms may be employed.

System components are also made user-installable, with the possible exception of wall plate replacement switches, dimmers and receptacles which can be installed by any electrician or handyman in the event that customer is not so skilled.

The system 100 is also made user-programmable by using simple setup functionality (e.g., simple GUI/menu structure or iconic representations), and intuitive prompting and/or scripting of the type well known in the UI arts. The system 100 can also be ordered by the customer in a fully programmed state based on inputs provided to the manufacturer or distributor; e.g., by answering a series of simple questions over the telephone, via a sales kiosk, via Internet, or even via mail-in survey.

As described in greater detail below, the system 100 also optionally employs software-based voice control from one or more microphones located, for example, in a camera assembly (FIG. 3), handheld remote device, or dedicated modules with microphones, to control one or more of the controlled devices such as lights, HVAC, TV/stereo channels, door locks, etc. To further aid convenience, remote LCD (or other type) touch panel server controllers are provided for controlling the server 102, as well as HVAC control and even other functions. For example, the 10″, 6″ and 4″ portable touch screen devices described subsequently herein are used in the site kitchen, front entrance, bedroom, or other desired location. The monitors can also be used to access the Internet, e.g., for web searches and email.

The line-powered phones 167 (FIG. 1) that plug into line-powered jacks can be adapted to provide Internet IP (e.g., VoIP) calls as well as traditional POTS capability, through use of a PCI telephony card of the type well known in the arts installed in the server 102. In one configuration, the telephones 167 comprise Ethernet line-powered IP digital phones, or Ethernet line-powered IP digital video phone that provides an intercom function as well as IP data/video/voice capability (e.g., videoconferencing via H.320, H.323 or comparable protocol). The phone(s) 167 may also be cordless; e.g., wireless devices.

The audio/video modules of the system may comprise any number of different configurations, such as for example (i) Universal Audio/Video Balun dongle over CAT-5; (ii) Universal Audio/Video Balun over CAT-5 or coaxial cable, but in a wall plate with A/V jacks (see FIG. 1, Zone C2); (iii) Ethernet LP A/V module as RJ (e.g., RJ-45) plug-in module (See FIG. 1, Zone C3); (iv) Ethernet LP A/V module as wired into wall plate with colored push on IDC CAT-5 pins; (v) Ethernet LP triple speaker driver as an RJ-45 plug-in module; and (vi) Ethernet LP double or triple speaker driver configured as an RJ-45 dongle.

The universal A/V CAT-5 balun (with and without an adjustable DC/DC converter power for the terminating device) advantageously provides signal transport for stereo plus composite or S-Video. The optional DC/DC converter accepts 48V input from the server 102, and steps down the voltage to 24V, 15V, 12V, 9V, or 6V to match the line-powered terminating device. Using the higher 48V supply at the server 102 over the CAT-5 cabling advantageously allows for the maximum power-transfer to the remote device(s), which allows up to 50 Watts in the exemplary configuration to drive video monitors, audio equipment, or other electronic devices.

An optional line-powered audio amplifier module (over CAT-5 cabling) provides a convenient way to drive audio speakers remotely over CAT-5 wire. In the exemplary embodiments, it is mounted in a dongle or a wired-in wall plate module. The speaker amplifier/driver comprises a switched mode amplifier, where the output is an integration of the square (chopped) voltage from the supply. This design is very efficient (>90%), which is highly desirable for line power applications.

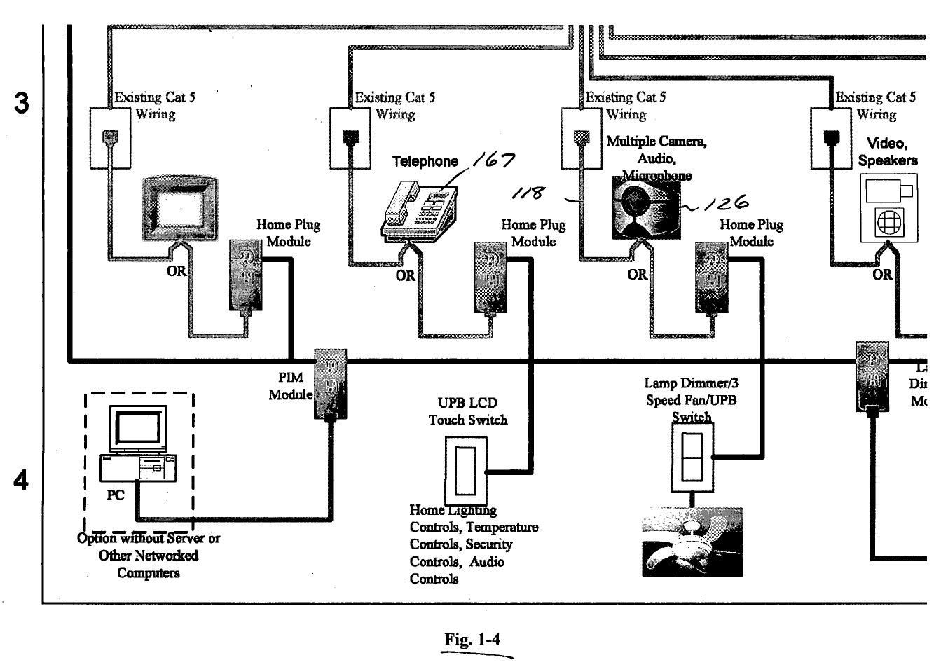

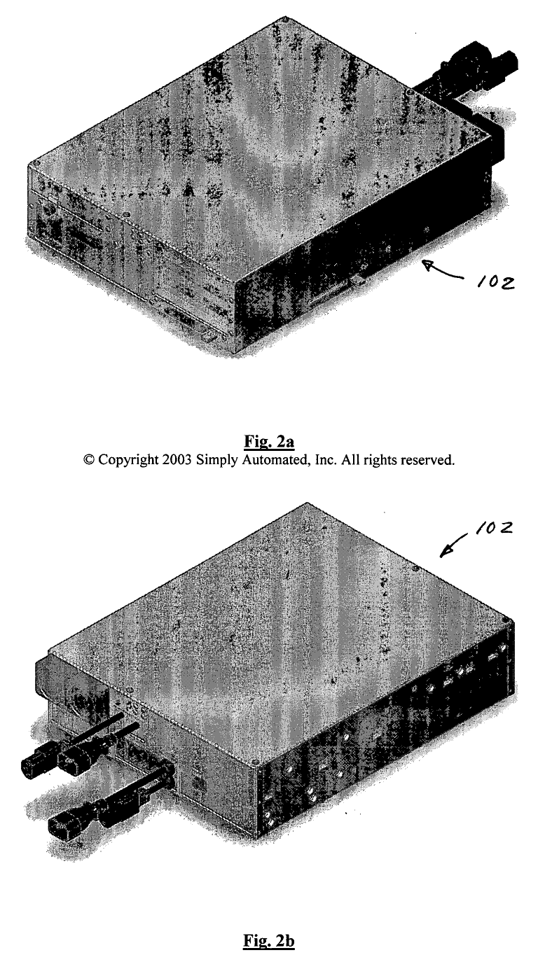

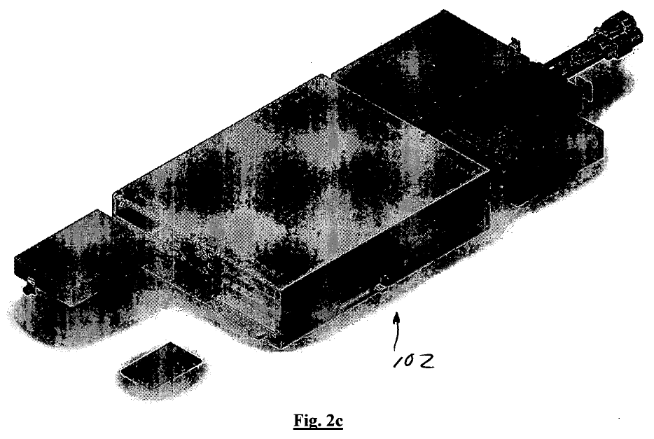

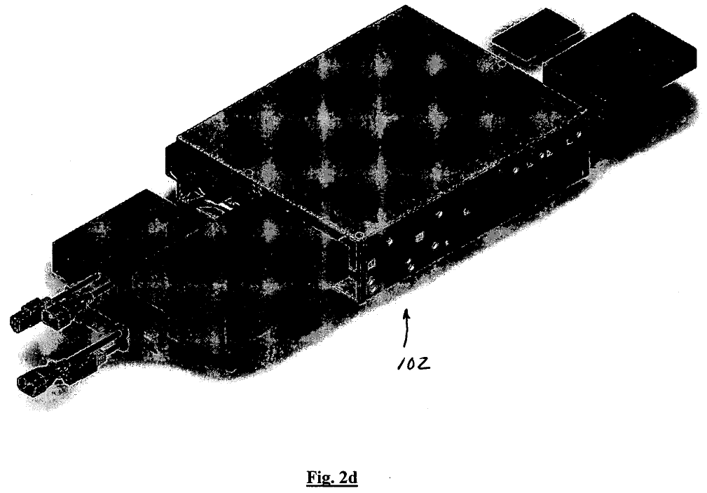

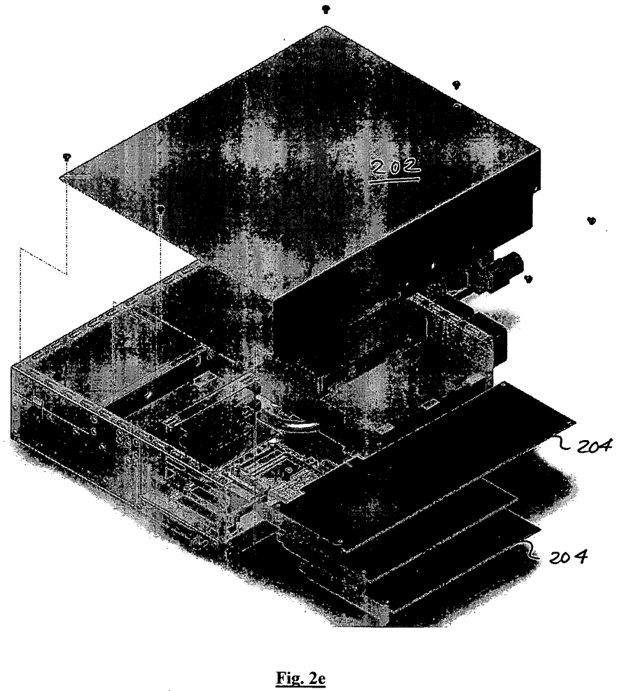

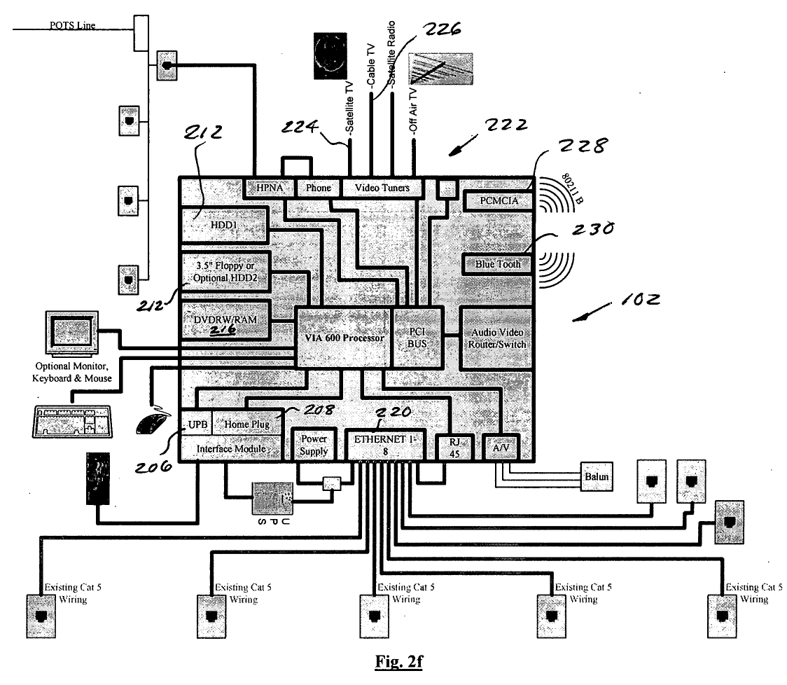

Referring now to FIGS. 2a-2f, one exemplary embodiment of the server 102 is described in greater detail. The device 102 generally comprises a housing 202 with motherboard(s) 204. On or interfacing with the motherboard are a plurality of components, including: UPB, HPN, and filter interface modules 206, 208, 210, one or more mass storage devices 212 (e.g., Ultra ATA, Ultra SCSI, or SATA hard drive, CD-ROM/CD-RW, floppy, Zip, RAID, etc.), DVD player/recorder 216, power supply 218, plug-in multi-port network switch with line power compatibility (e.g., Ethernet 802.3af compliant) 220, off-air PCI tuner with or w/o a HDTV decoder) 222, satellite PCI tuner with or w/o HDTV decoder 224, Multi-line PCI phone card, DOCSIS/OCAP 1.0/2/0 compliant RF CATV front end tuner and demodulator 226, one or more PCMCIA slots 228, and wireless interface card 230. A digital processor 232, DMA, RAM and flash memory, and PCI controller 234 are also provided as is well known in the computer and embedded device arts. As will be described in greater detail below, many of the foregoing components are made modular, such that the user can both readily replace them and custom-configure their own individual server 102.

The exemplary server uses a Linux operating system (O/S), although it will be recognized that other O/S may be used including, e.g., MS Windows, Sun Solaris/UNIX, and even DOS if desired. The server architecture, while optimized for the selected Linux operating system, is completely O/S independent in that regard.

The server 102 is also optionally configured with one or more of the following features: (i) voice-activated control (e.g., based on speech recognition algorithm); (ii) UPB Control; (iii) HomePlug broadband capability; (iv) audio/video interface; (v) simplified intuitive user interface (UI); (vi) software-based calendar, with appointment reminders that includes “intelligent” localization of participant using a predetermined series of phone numbers or other contact mechanisms; (vii) software based juke box functionality to provide easy access to CDs recorded on the server (or otherwise accessible thereby via one or more data interfaces) for playing by the user; (viii) address book function; (ix) recipe and grocery list manager function (the latter which may be interfaced with Internet based shopping sites, such as e.g., the well known Vons Internet grocery shopping website); (x) personal inventory manager and automotive or other vehicle maintenance logs; and (xi) self diagnostics to locate and alert the user of the need for a replacement module or other equipment malfunction.

The server 102 of the illustrated embodiment is designed with connectors and slide-in slots which are substantially standardized, such as for a standard off-the-shelf DVD recordable drive, one or more IDE/Ultra ATA/Ultra SCSI/SATA hard drives providing more than 800 GB of storage capacity, a low cost power supply with a output plug (rather than cords), a multi-port network (Ethernet) switch with line power (LP), and a power line interface module which includes the UPB and HP interface as well as the signal conditioning (e.g., filtering) to block spurious of undesired components of the power supply (and optional battery back up supply). All of the power supply (including optional battery back-up) is accomplished with only one power cord, no multiple plugs or power supply modules are required (see FIG. 1). All of the modules simply plug into the slots, and are held in by the thumbscrew retainers, or even other fasteners of the type well known in the art (including for example, snap-latches, button latches, etc.). The server 102 also has multiple slots (e.g., 4) for PCI cards, and PCMCIA slot(s) and other of the most common interface ports of a standard PC. To remove and install the various cards within the server 102, one simply removes the cover and slides the cards out or in. (see FIG. 2e).

The speech recognition functionality of the illustrated embodiment includes a high quality, high SNR audio microphone, analog-to-digital converter (ADC), and algorithm run on a digital signal processor (DSP). It will be recognized that various forms of spectral analysis, such as LPC (linear predictive coding), MFCC (Mel Frequency Cepstral Coefficients) or cochlea modeling, may be used. Phoneme/word recognition in the present embodiment is based on HMM (hidden Markov modeling), although other processes such as, without limitation, DTW (Dynamic Time Warping) or NNs (Neural Networks) may be used. Myriad speech recognition systems and algorithms are available, all considered within the scope of the invention disclosed herein.

FIGS. 2g-2j illustrate an alternate embodiment of the server 102. This embodiment is particularly adapted for user repair, specifically through use of plug-in modules and a guide system shown in FIGS. 2g-2j. The plug-in modules of the server 102 each have 2 rails attached to respective sides of the modules. These modules include e.g., mass storage device, DVD/CD drives, power supply modules, UPB/HomePlug, and 8-port POP Ethernet modules.

FIGS. 2g and 2h shows top and side views of an exemplary rail 288 according to the invention. The latch hooks 289 of the rail 288 latch into the apertures 291 of the slide channels 290 as shown in FIG. 2i. The insertion guide 292 aligns the connectors 297 of the modules and the back plane 298 (FIG. 2j) by being received within corresponding apertures 296 within the back plane 298. An optional PCB extension 299 may also be used with or without standard cable interfaces as is well known in the art.

Finger pull levers 295 are also optionally provided so as to make removal of the module(s) from the server 102 easy. The use of side rails 288 and corresponding channels 290 minimize the overall case size, as well as providing a low-cost package, and ease of insertion for the homeowner.

Referring now to FIGS. 3a and 3b, exemplary camera apparatus useful with the invention are described. In one embodiment, the apparatus 300 comprises a highly integrated device having a low-cost Ethernet room camera with optional stereo speaker(s), microphone for intercom and/or voice control, smoke detector with light and battery back-up, room temperature sensor, motion detector (e.g., IR or ultrasonic), and ambient light level sensor.

Furthermore, a porch camera can be implemented over existing wiring. Additionally, a screw-in flood light camera assembly with motion detection and light is provided (see FIG. 3b). As shown in FIG. 3b, the exemplary embodiment of the light 302 comprises a free turning, tool-installed base 304 (to frustrate theft), removable lens cap 306, camera lens and aperture 307, and LED (e.g., white light) array 308 which provided low power consumption and heat generation. Ethernet and HomePlug interfaces are also optionally provided to permit streaming of data from the camera (or other associated sensor) to the server or other node within the system 100.

The improved porch camera/door bell button of the exemplary embodiment is user-installable over any existing doorbell wiring using a module at the doorbell transformer. It optionally includes a speaker and microphone for intercom functionality throughout the premises if desired. An optional light is also provided for viewing if porch light is out. A motion detector is provided for security by alerting the user when someone or something is on the porch, and a camera unit can automatically record the event. An optional thumbprint, keypad, voice recognition, or even retinal scan sensor is also provided for keyless entry. A powered keyless deadbolt entry system (with battery backup in case of power outages) may also be utilized for further security.

Referring now to FIGS. 3c and 3d, one exemplary embodiment of an external (e.g., porch) controller module according to the invention is described. The controller module 310 of FIG. 3c is configured as a broadband device that advantageously utilizes existing wiring, and is made self-installable by the user. For example, in a typical premises installation, the user's doorbell button is removed, and replaced with the controller module 310. A bypass capacitor 314 must also be installed across the existing door bell circuitry 316 to permit coupling of the HomePlug data and/or control signals, as well as a high-frequency bypass transformer 318 across the 120V/16V transformer 320 as shown in FIG. 3a.

The HomePlug controller module 310 can optionally be configured to communicate with the house server/controller 102 (see FIG. 2) or comparable devices to transmit the camera 330, microphone 332, thumb print scanner 334, key pad 336, and door button 338, key card (not shown), etc. information or signals obtained by the module 310 to the server 102. The server 102 can also be used to also control the module lighting, audio speaker, and optional door lock functions of the module 310, although one or more of these functions may also be controlled locally (e.g., via logic internal to the module 310 itself). The module 310 may also be environmentally sealed as is well known in the art in order to preclude the ingress of moisture, corrosive agents (e.g., salt air), etc.

FIG. 3d shows a narrowband exterior (e.g., porch) module 350 that includes a PIR (passive IR) or other motion detector 352, key pad 354, and/or thumb print scanner 356, and communicates with a UPB controller 358. Again, the existing doorbell itself must be bypassed with a capacitor 360 as shown in FIG. 3d. However, the high-frequency bypass transformer of FIG. 3c is not required in this narrowband application.

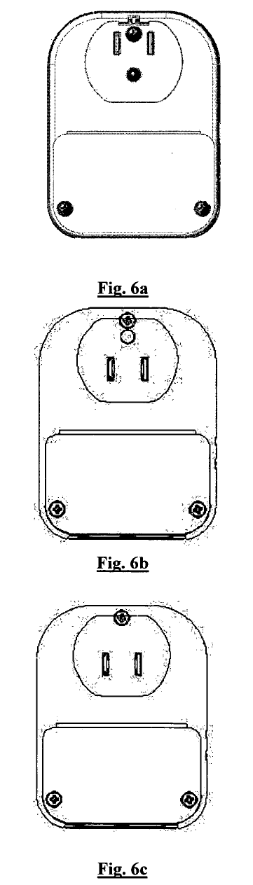

Referring now to FIGS. 4a and 4b, a first exemplary embodiment of the UPB duplex plug-in modules 400 of the invention are described. In the illustrated embodiment, the module 400 comprises a substantially rounded or arched housing 410 which comprises a molded polymer, although other shapes and materials may be used. The illustrated arched design is highly aesthetic, but it is also extremely strong and can support large weight and substantial impacts. The device 400 is further equipped with a plug-in plug or jack to eliminate the need for hand soldering, as described below. The wall plug and jack orientation have a molding option which allows inversion of the housing (i.e., to either hang down, or alternatively hang “up” to permit the stick-able IDC wire described below to be routed out the top and to connect to lights or other wall appliances; see FIG. 6).

The duplex wall plugs have a “no solder” construction with eyelets that are first wave soldered in the PCB 430 with the other parts; then, the 3 terminals (two AC and ground) are physically pushed in and snapped into place without any soldering. This approach saves significant manual operation during manufacture and installation.

The illustrated pass-thru duplex socket is optional in the mold, as are the terminals which may be broken off at a scored area as desired. This feature allows significant flexibility in application,, since the same unit can be used for a number of different types of installation.

The bottom opening 450 of the arched housing 410 has multiple shrouds that are inserted into the housing, which accommodate the following types of exemplary interfaces (see FIGS. 5a-5f): (i) duplex II 5V receptacle; (ii) 16-port push connector strip used on the sprinkler and I/O module; (iii) RJ-type right angle Jack for Ethernet or other network port; (iv) DB9 interface for serial port; and (v) slide switch lever opening for the test module and other IDC connector configurations for the various tape wire applications described herein. The module 400 may also include optional power sense technology. A 15 A current capacity is provided, although other values may be used.

One or more “wired-in” modules may also be utilized with the system 100. For example, a UPB electric water heater control module is provided to allow control of the water heater functions, e.g., shutting off power at peak demand requirements. Similarly, a UPB 3-speed ceiling fan control, with built in temperature control (and optional light dimmer), may be used. Other possible modules include, without limitation, (i) UPB controlled dimmer for light or bath fans or other appliances; (ii) UPB controlled relay (same as above, except no dimmer function); (iii) UPB controlled 115 VAC fluorescent lamp dimmer; (iv) UPB low voltage controller for curtains, drapes, screens, door/window locks, and other low-voltage AC or DC self-install devices.

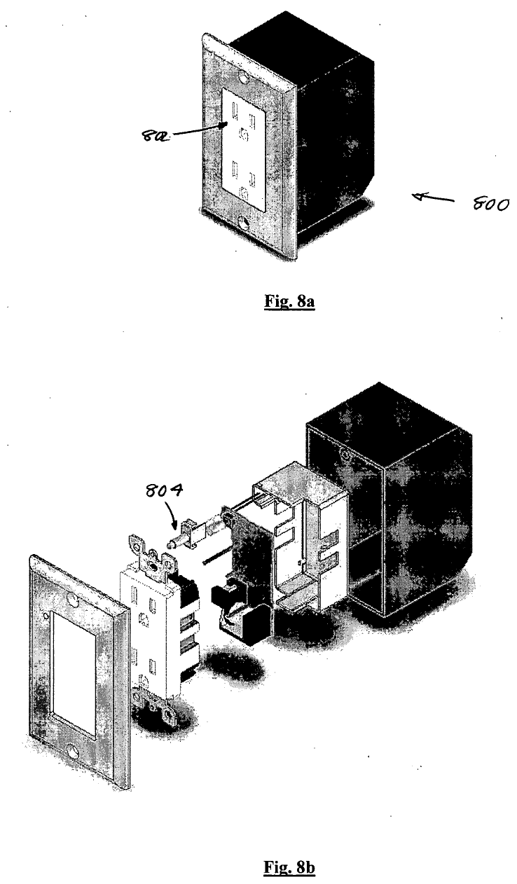

Also provided with the system 100 are one or more wall plate modules (see FIG. 8). These modules comprise, in the exemplary embodiment, one or more duplex receptacle controllers to switch on/off associated receptacles. The exemplary device fits both standard and Decora receptacles, although other configurations may be used. In another configuration, a low cost single- or dual-rocker dimmer switch is provided. Each may also be fitted with a relay if desired as well. The UPB controls the relay, which switches up to the 15 A current to the load. Each wall plate switch device may also include a socket for the plug-in sensor module (described below).

In yet another embodiment, a fluorescent rocker dimmer module is provided. Most prior art dimmers are not compatible with fluorescent ballasts; however the present design advantageously provides a broad range of compatibility, thereby further simplifying installation.

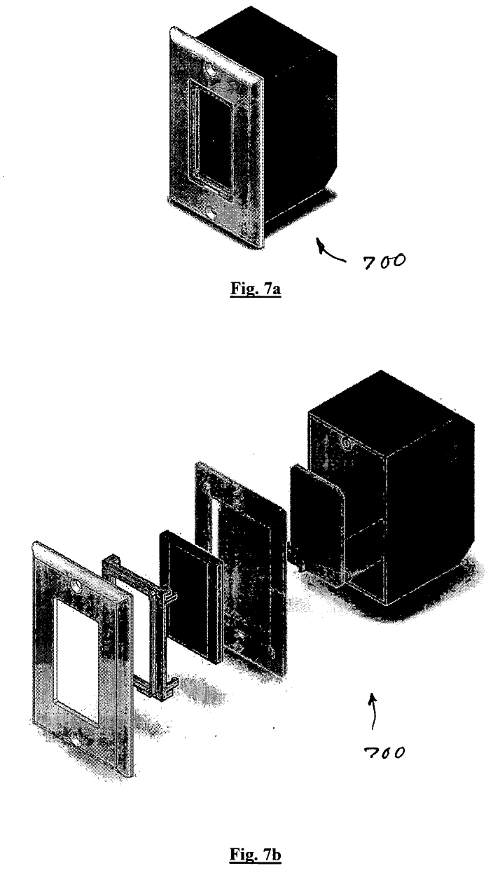

A universal LCD, resistive, or capacitive touch screen multi-button dimmer/switch, such as that of FIG. 7, may also be used. The module may also comprise IR, temperature control, and/or motion detection functionality. For example, in one embodiment, a plug-in motion/temperature/IR/sensor and acoustic or optical “sounder” module for the wall plate switches is provided. This module plugs onto the wall plate switches and dimmers (i.e., at the top of the illustrated embodiment) by removing the top wall plate screw and replacing it with the supplied screw, and special washer, thereby providing a structure for the sensor module to snap onto. The sensor has a plurality (e.g., 4-5) of pins which plug into the wall plate dimmer/switch, and snaps into place.

As shown in FIG. 7, the exemplary embodiment of the universal programmable multi-button touch screen wall plate controller is made totally programmable with the following features and functions: (i) owner selectable multi-color LCD back lighting to match the rooms wall decor; and (ii) multi-function LCD, resistive, or capacitive touch screen which can become a simple 1-button dimmer, or 1-7 additional control “buttons” can be added by the user to control other dimmers, or switches or other functions such as an alarm, master all-lights-off switch, garage door switch, or other desirable controllable function. Furthermore, the screen can also provide additional information for the homeowner including, without limitation, time of day/date, ambient (inside) temperature, outside temperature, various alert messages, audible alarms with plug-in module, as well as even miscellaneous entertainment information (e.g., horoscopes, moon phases, tides, calendar schedules, “to do” reminders, etc.).

A self-install optional plug-in module can be plugged onto most of the wall plate switches/dimmers to provide more control and feedback information to the server 102, such as for example (i) temperature sensor which is used by the server's temperature control system; (ii) motion sensor is used to turn lights on/off or provide intruder information; (iii) IR sensor accepts inputs from the remote unit to instruct the server 102; and (iv) sounder for alerting the owner of an alarm or other urgent notifications.

Other control apparatus may be used consistent with the present invention as well. For example, the devices and methods set forth in co-pending U.S. Provisional application Ser. No. 60/607,148 filed Sep. 3, 2004 and entitled “UNIVERSAL CONTROL APPARATUS AND METHODS”, incorporated herein by reference in its entirety.

From a supply and manufacturing perspective, the foregoing approach of user programmability and reconfiguration allows stocking of fewer type of controls, and also allows for higher volume (and thus less per unit cost, which is ultimately passed on to the consumer).

The motion sensor of the module provides room occupancy detection to the server 102; this information can be used, inter alia, to turn lights on when someone comes into the room, and turn the lights off when no one is present in the room (or when someone is present, but no motion is detected, such as during sleep). The “off” functionality may be controlled by one or more parameters, such as a lack of detected motion for predetermined period of time. The motion sensor may be IR-based, ultrasonic (e.g., Doppler-based, keyed on frequency shifts), or any other suitable technology.

The motion sensor can also be used to trip the security alarm, video monitoring, silent alarms at remote locations, etc. if the house is broken into when the alarm function is set.

The module's IR detector can also receive information from other remotes sending signals to the server 102, such as to initiate additional monitoring, to form a coincidence logic circuit (e.g., 2 of 3 different sensor “hits” before alarm activation), etc.

The sounder unit of the module provides an alarm to other rooms for any number of functions, such as broadcasting an emergency condition, calling a family to dinner, waking an individual at a given time, or other notification desires. These alarms may be audible, visual, or both, or may also trigger a remote or client device (such as a vibratory pager of the type well known in the telecommunications arts).

In another aspect of the invention, a convertible duplex receptable controller 800 is provided that plugs onto a standard duplex wall receptacle to add control for the top receptacle (see FIGS. 8a-8b). The controller plugs onto a standard or Decora duplex wall plate dual receptacle, and selectively switches the top socket 802 only. The device also has a built-in lighted multi-function convenience button 804, which initially assists in the programming process, but later functions as a toggle (on or off) for the switched socket. The lighted button also provides a timer function which is initiated by the user; e.g., by physically tapping the button one or more times.

In another aspect of the invention, an integrated common remote control unit is provided. Since a plurality of devices within the system 100 are under control by the server 102 or its proxies, a single remote unit can control all of these devices through, e.g., multiple IR sensors located in many of the rooms. This approach obviates the expense and effort required to generate a “universal” remote of the type known in the prior art. These prior art devices have been shown to be unreliable as well as costly, and generally only useful in a main room (e.g., living room) of the premises. Many large screen viewing devices or TVs do not have tuners (including notably HDTVs). The server 102 of the present system 100 advantageously allows for interface of such devices because the various tuners are built into the server 102, and the video signal is simply transported from the server 102 to the device (HDTV), or to multiple screens. Accordingly, flat screen devices can be wall mounted almost anywhere, and powered, fed signal, and controlled by the server 102. The touch screen remote unit easily allows the user to select icons (and/or menu structure with or without graphic displays) in order to permit intuitive navigation to the desired function and room locations. All functions can also be voice controlled from any room equipped with a microphone, such as where the microphone is disposed within the aforementioned camera(s), even including the front porch camera or hand-held remote.

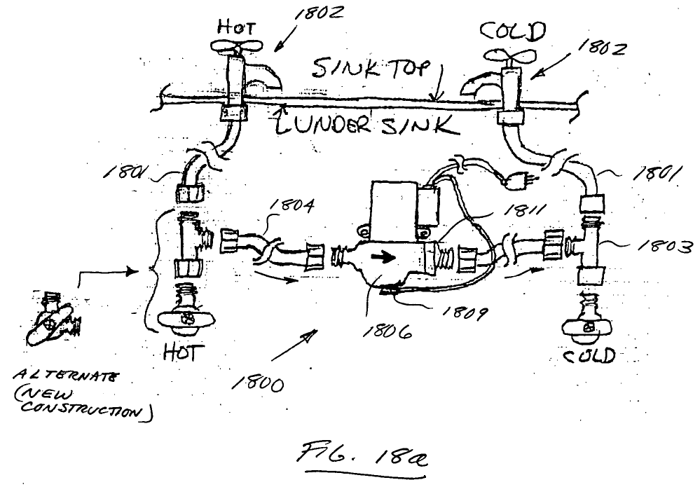

A plurality of different remote unit configurations may be used with the invention as well. For example, a table-top or hand-held remote unit having a plurality (e.g., 8) buttons that can be located at a convenient location to control room lights, outside lights, bathroom lights, fans, security system components, or other UPB devices. In another embodiment, a table-top or hand-held LCD/touch screen reconfigurable remote is provided; this device has similar functionality, except that the LCD/touch screen offers programmability and communications with the server 102 such as security alarms, HVAC control, listing and changing TV/Radio channels, interactive program guides (IPGs), web browsing, etc. The foregoing devices may be wired, or alternatively wireless for enhanced portability. See, e.g., the discussion relating to FIGS. 17a-17b provided subsequently herein.

Other ancillary components of the system (and associated installation kit) of the present invention include: (i) UPB controlled screw-in light bulb “puck” (wafer) dimmer, that allows home owner to control individual bulbs in porch or closets, front lawn lights, etc.; (ii) UPB control module, which plugs into back of a duplex receptacle to control the top receptacle (see FIG. 8); (iii) provision of a hand-punch or other implement for provisioning wall receptacle cover plates to accommodate one or more push button lights for UPB controlled duplex socket, thereby allowing the use of any standard or Decora plate cover; (iv) plug-in filter for improving loading of HP from input capacitance on some appliances, suppression of noise for some problem products having a long run from power lines to the pole-mounted supply transformer, or for blocking noise from switching power supplies or electronics for Home Plug attenuation.

The aforementioned screw-in dimmer puck (wafer) shown in FIG. 1, Zone D3 allows the user to unscrew a light bulb, and screw in the dimmer puck (with the supplied insertion tool), and then screw the light bulb back into the fixture. The UPB controlled dimmer puck of the exemplary embodiment is approximately ¼″ (one quarter inch) thick, although other thickness values and configurations may be used. The exemplary remote dimmer will drive up to 150 Watts, and can advantageously be controlled from any of the UPB controllers and switches. The puck also provides a heat sink for the bulb into the lamp socket, thereby avoiding any thermal energy dissipation issues.

In another aspect of the invention, an improved “universal” wafer phase bridge is disclosed. Specifically, using lighting control over house power lines can have problems transmitting from one phase of the (e.g., 115V) power to the other −115V phase when the pole power transformer is not physically proximate to the premises. This is a particular problem with prior art technologies such as those manufactured by X-10 Technologies Corp. Typically, for X-10, this may be addressed somewhat by adding an inductor in series with a capacitor, and bridged from one phase to the other. To make the phase connection under the prior art, Smarthome Corporation offers a large housing with an integral electric dryer plug and jack with the inductor/capacitor wired inside. A similar housing for the electric stoves is also available, and these sell presently for about $50 USD.

The solution of the present invention is advantageously much less expensive and much smaller (and safer in the case of LEDs, as described subsequently herein. The design uses a multi-layer PCB or other substrate that has spring eyelets that are soldered into the slots in the PCB. The slots with the eyelets form a connector, and the connectors are physically located on the board to match the appliance or device (e.g., electric dryer) plug, as well as optionally that of other devices (such as an electric stove plug) at a fraction of the cost compared to the prior art Smarthome design. The bridging circuitry of the illustrated embodiment is located on the PCB, just above where the plug is received. An optional protective cup is attached over the circuitry to protect the circuitry as well as the user.

For the aforementioned prior art X10 technology, the cap and inductor works to some degree, yet is not optimized. The UPB bridging of the present invention, although not often required, is generally accomplished in one of two ways: (i) a simple 15 uf/400V or similar capacitor across the phases works quite well, but is seldom required; (ii) an improved, highly coupled center-tapped inductor with the center tap connected to the neutral, with the ends of the inductor coupled to the 2 phases through capacitors. This approach has the advantage of not bucking the natural phase (voltage) reversal, but rather ensuring the opposite phase.

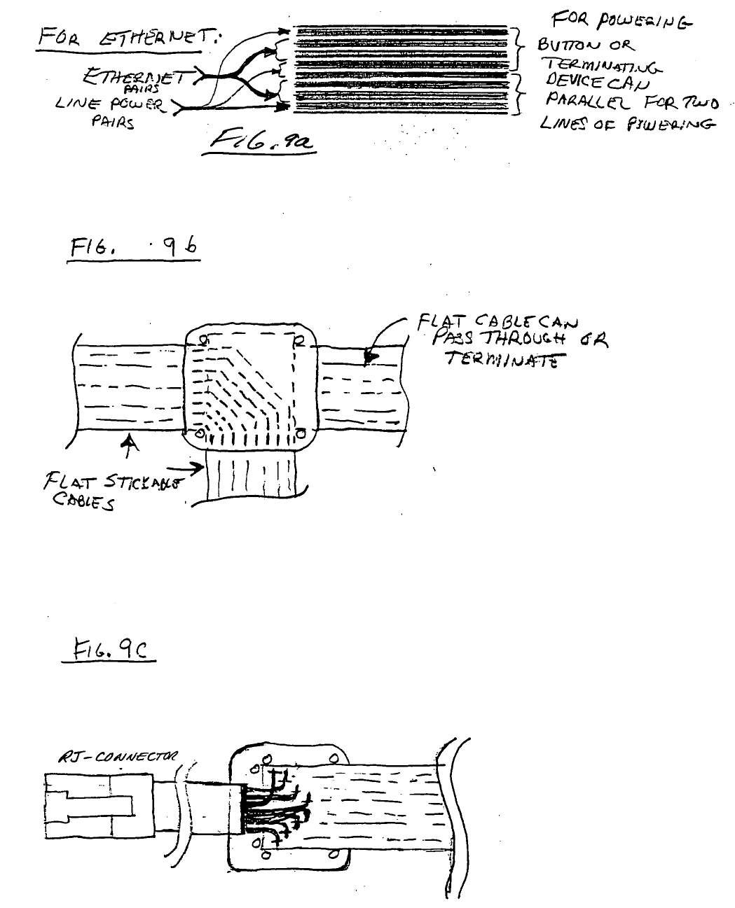

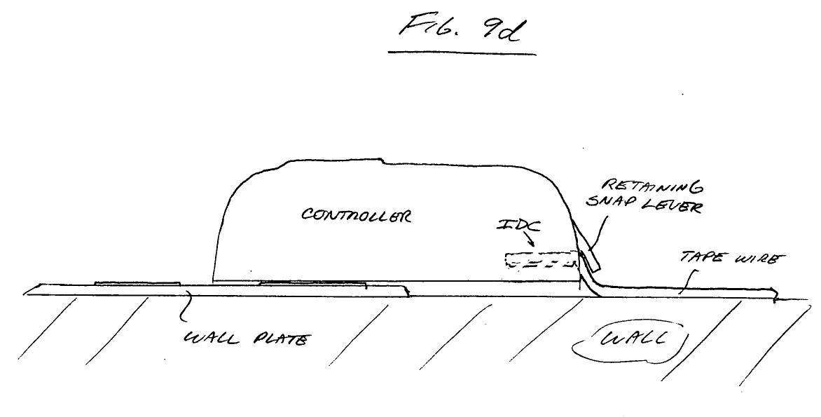

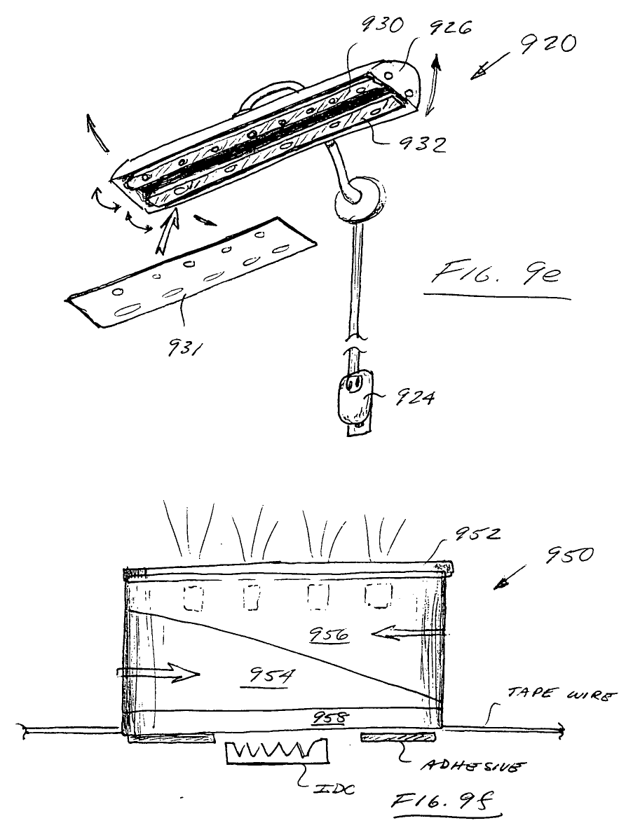

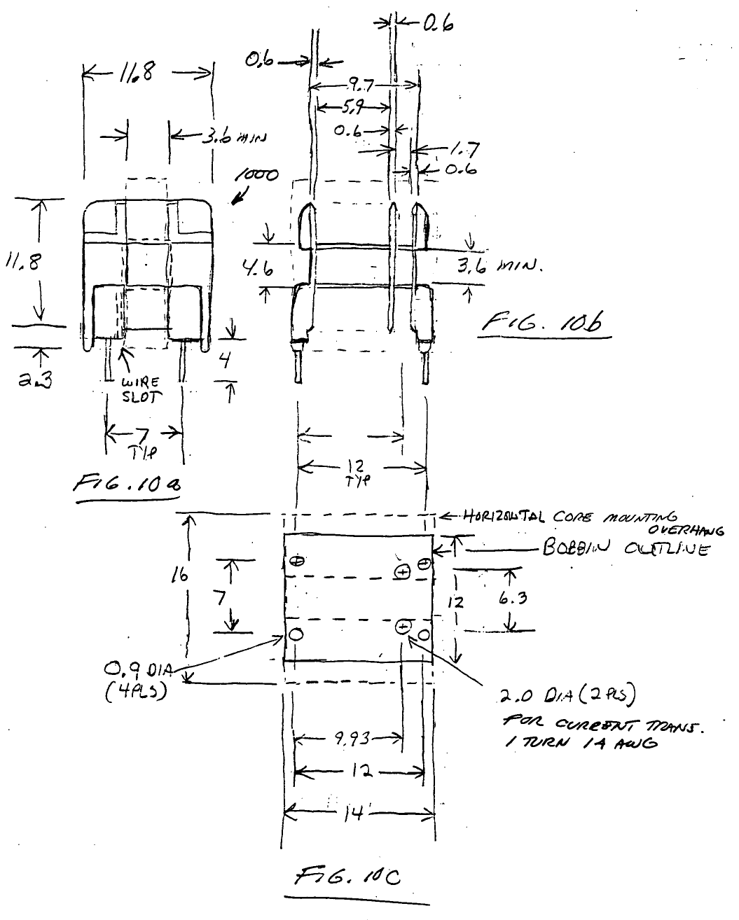

In yet another aspect of the invention, a plurality of insulation displacement contact/adherent self-installable products are provided, as shown in FIGS. 9a-9f. A plug-in 12V dimmer power source is provided, as is a tape wire arrangement which is both self-adhering and paintable. Several widths, insulation types, physical form factors, and conductor configurations are available for various types of applications, such as power, communications, and sensors. One such exemplary product comprises user-mountable daisy chain halogen decorative, adjustable direction spot or accent lights. Other exemplary devices comprise user-mountable fluorescent under- or over-counter dimmable lighting, motion/temperature/IR sensor, register enhancer (fan/damper), and water leak sensors. LED lighting (see FIGS. 9e and 9f) may also be used; these devices provide the benefit of enhanced premises safety against fire as compared to incandescent or other lighting systems.

User installation of these systems is made very simple. For example, referring to FIG. 9b, the user need merely cut the flat stickable wire to a desired length (using, e.g., scissors), align the cut flat wire with the guides of the IDC “button”, and snap the wire into place using e.g., a cover element and pliers or other tool capable of applying pressure. Similarly, with respect to FIG. 9c, the user merely cuts the wire to the desired length, places the wire on the IDC element, and snaps the cover into place using pliers, etc.

The simple IDC flat wire design also permits adaptation to “button” designs such as, for example, corner connectors (“Tees”) for splitting into 2 directions. Other buttons are also provided for particular applications such as an adapter to regular speaker wire or balun applications, or a splitter to smaller multiple smaller cables. Some buttons can parallel some of the standard multiple wires tapes for other multifunctional higher current applications. The stickable IDC of FIG. 9 can be used with various applications such as window/door sensors, lighting control, or literally any other electrical application. For self-install applications, tape wire is a very convenient and simple way for the user to run wires on a surface, and the tape wire is made paintable so that its coloration and texture can be matched to its surroundings if desired. The tape wire is simply cut with scissors and mass terminated with the IDC terminating devices or splicing buttons. The tape wire may also include adhesive on both sides, thereby allowing inter alia the tape to be folded over onto itself so as to execute one or more 90-degree bends or turns in the tape wire as it propagates across a surface.

As one example, stickable tape water leak sensors are provided with the system, thereby allowing implementation of the water conservation and isolation functions previously described herein. This protects against costly repair from potently leakage problems such as water heaters, icemakers, dishwasher, and hose failures, sump pump or other potential areas. This is particularly significant, since the average insurance repair of home water/mold damage is one the order of $25K USD. Optionally, the system 100 disclosed herein can be configured with software adapted to sound alarms, call one or more telephone numbers, and/or initiate one or more e-mail or SMS or similar transmissions to alert the user or other personnel as to the problem and shut off or isolate affected systems or components.

Referring to FIGS. 9e and 9f, various embodiments of a low voltage LED lighting systems according to the invention are described. As with other apparatus described herein, the LED lighting system is advantageously made user-installable.

FIG. 9e illustrates an exemplary “portrait” lighting fixture 920 that is wall- or surface-mounted to provide a localized and power efficient source of illumination. The illustrated embodiment is affixed to a wall or other surface using, e.g., and adhesive, and uses a tape wire interface to a local wall-socket module 924 (e.g., UPB) as previously described herein. The fixture 920 is optionally made adjustable in pattern, color, and diffusion using, e.g., lenses that can be used to create different lighting patterns. In one embodiment, a rectangular or bar-type lens configuration is used. In another embodiment, a round adjustable lens is provided, with a “goose neck” type fixture. Myriad other shapes and configurations will be appreciated, the foregoing being merely illustrative of the broader principles.

The exemplary fixture 920 of FIG. 9e uses a heterogeneous LED system, wherein a first set or rail of LEDs 930 is used to provide a narrower field of illumination, while the second set 932 is used to provide a wider field. The narrow-field set of LEDs includes more LEDs per linear inch, thereby increasing the illumination density to compensate for the longer distance to the bottom of the portrait. This approach provides a longer vertical light profile so as to illuminate the bottom portion of the portrait as well as the top, and also makes the illumination more uniform across the vertical expanse of the portrait.

Rotation of the fixture head 926 causes rotation of the two LED arrays relative to one another (and the portrait), thereby allowing the user to create a multiplicity of different lighting patterns on the portrait. A 2-way lens system 931 may also be used, thereby allowing the user to generate a smaller or larger patter of illumination on the wall/portrait. When the lens is placed in one orientation, it creates a smaller pattern, whereas the other orientation produces a larger pattern.

Any number of different LED configurations may be used in the fixture 920, including white light LEDs, colored LEDs, “soft incandescent” yellow LEDs, etc. The use of LEDs for lighting provides several benefits, including increased longevity of the LEDs, and reduced power requirements over incandescent or even fluorescent systems. Reduced heat generation also significantly reduces any fire hazard or thermally-induced degradation of surrounding components (e.g., wallpaper, decorative fixtures, etc.).

The module 924 provides the adjustable 24 VAC 60 Hz power to the LEDs using small triac devices of the type well known in the electronic arts, although other approaches may be used. The module 924 and fixture 920 are interconnected using the tape wire approach previously described herein.

FIG. 9f illustrates another exemplary embodiment of the LED lighting fixture of the invention. As shown in FIG. 9f, the fixture 950 comprises a substantially cylindrical multi-segment structure. The lens 952 and segments of the structure 954, 956 are articulated relative to one another such that a wide variety of lighting combinations and orientations may be produced form the same fixture 950. The exemplary device is wall or surface mounted using, e.g., an adhesive or double-sided tape backing, and is electrically coupled to other fixtures (and the local power supply module) using tape wires as previously described. An IDC contact member 960 is also provided with the fixture in order to permit electrical interface with the tape wire.

The first segment 954 of the fixture is allowed to rotate around the base portion 958 so that the other segment 956 can be disposed in alternate positions. When the second segment 956 is in its nominal position (as shown), the rotation of the first segment 954 around the base 958 produces no change in the general orientation of the second segment 956. However, when the second segment is rotated around its interface with the first segment 954, the angled surface of this interface causes the lens 952 to point in a different direction. Accordingly, when the first segment 954 is then rotated, the second segment and lens are also rotated. Hence, the fixture 950 can advantageously sweep out a broad illumination pattern through adjustment of the first and second segments 954, 956. Rotation of the optically asymmetric lens 952 relative to the fixture 950 also provides a varying illumination pattern, thereby providing the user with many degrees of freedom in generating a desired lighting pattern and intensity. For example, in one position, the lens 952 provides a more focused, intense pattern, whereas in another position it provides a more diffuse, broader coverage. Myriad different lens configurations will be appreciated by those of ordinary skill.

It will be appreciated that various combinations and variations of the foregoing embodiments of FIGS. 9e and 9f may be used consistent with the present invention. For example, instead of a two-rail/set configuration, a single rail or more than two rails of LEDs may be used. Similarly, different types of LEDs can be intermixed for a desired lighting effect, or can be selectively switched on or off for different “themes” or characters of lighting (e.g., a soft, more yellow and diffuse theme for certain times of the day, and a brighter, more intense theme for other times. Any number of other variations in the LEDs, fixture, or supporting components will be readily recognized by those of ordinary skill.

Referring now to FIGS. 10a-10c, an improved current transformer bobbin 1000 is disclosed. In the illustrated exemplary embodiment, the bobbin comprises a 16 mm bobbin with vertical or horizontal core mounting. The following design features are provided: (i) vertical EI orientation (“EI” here referring to the appearance of the cross-section of the device, which appears to form the letters “E” and “I” juxtaposed) for minimal PC board space; (ii) horizontal EI orientation for minimizing height; (iii) improved bobbin pin design to minimize PCB foot print and also accommodation of multi EI lamination orientations; and (iv) bobbin features for holding the last “I” lamination during assembly, also gluing which saves assembly costs; this feature eliminates the need for the usual EI thick aluminum bracket that is also costly and adds to the transformer costs. The illustrated embodiment of the bobbin 1000 is a current transformer which has a narrow third winding flange, the latter which provides a narrow slot for a single-turn thick primary winding where the wire is also formed to become the primary pins. However, the general design approach and features described above are directly applicable to non-current sense transformer applications, as well as even other types of devices.

Network Configurations

Referring now to FIG. 11, an exemplary network configuration according to the present invention is described. As shown in FIG. 11, the communications server 102 provides local and remote access and control relating to a plurality of communications, network management and control systems and functions including a local area network (LAN), Internet access, e-mail management, home automation and control, and other communications systems such as telephony.

FIG. 11 shows a system block diagram of one embodiment of the communications server apparatus 102 and associated network components. The server 102 comprises a first network interface 1110 optionally coupled to a first network communications channel (e.g., DSL, Cable modem, wireless link, etc.) for communications with the a public or private internet 1101 (e.g., the Internet), and a second network interface 1160 optionally coupled to a second network communications channel (e.g., Ethernet, WiFi, LAN, coaxial cable network, etc.) for communications with a private local area network (LAN) 1102.

The illustrated embodiment of the server is implemented using various software applications that are stored in the mass storage device 1140 and RAM 1130, and executable to run on processor 1120. These software applications include a network address translation (NAT) proxy application providing devices connected to the LAN (and having addresses that are not able to be routed on the Internet) with the ability to communicate on the Internet. A web server application including a user interface (UI) for local and remote access and control of a plurality of communications operations is also provided. Other applications running on the server 102 may include network management and control systems (NMCS); an Internet access application providing one or more devices on the LAN with simultaneous access to the Internet through a shared Internet service provider (ISP); an e-mail management application (e.g., unified messaging or the like) providing centralized collection and management of e-mail from multiple e-mail servers; a facsimile receipt, storage and forwarding application providing the premises with centralized reception, storage and forwarding of facsimile data; and a premises automation application providing local and remote access and control of home or premise equipment including appliances, HVAC equipment, lighting, sprinklers, water systems, sensors, monitors, etc. as previously described herein.

The signaling interface 1170 of the server 102 is coupled to an AC power line signaling interface 1103 (which may or may not be integrated with the server 102), to inter alia, generate control signals for control of downstream devices. The AC power line signaling interface 1103 receives control signals from the signaling interface 1170 and modulates them onto the premises AC power distribution system for distribution to the end devices (e.g., control modules, etc.). AC power line signaling interface 1103 also receives signals from downstream AC power line signaling interfaces 1104₁ through 1104ₙ and demodulates them as required to generate a baseband signal readable by signaling interface 1170.

As previously noted, the server apparatus 102 may also include a telephony subsystem 1180 (including a call and voice processing application or unified messaging capability) providing enhanced call processing capabilities to the premises. This device 1180 may interface with, e.g., a PSTN or other similar telephony network.

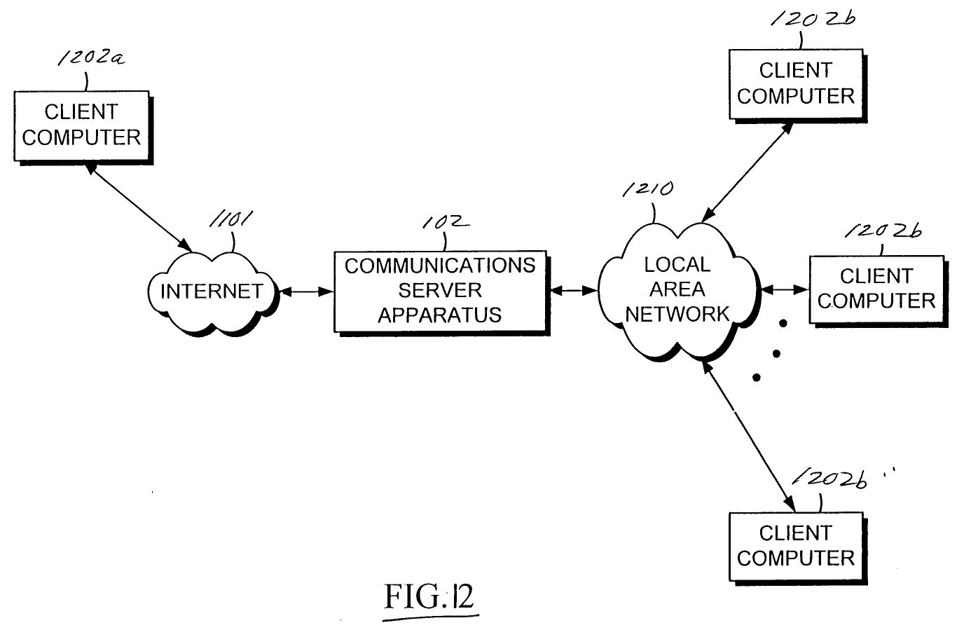

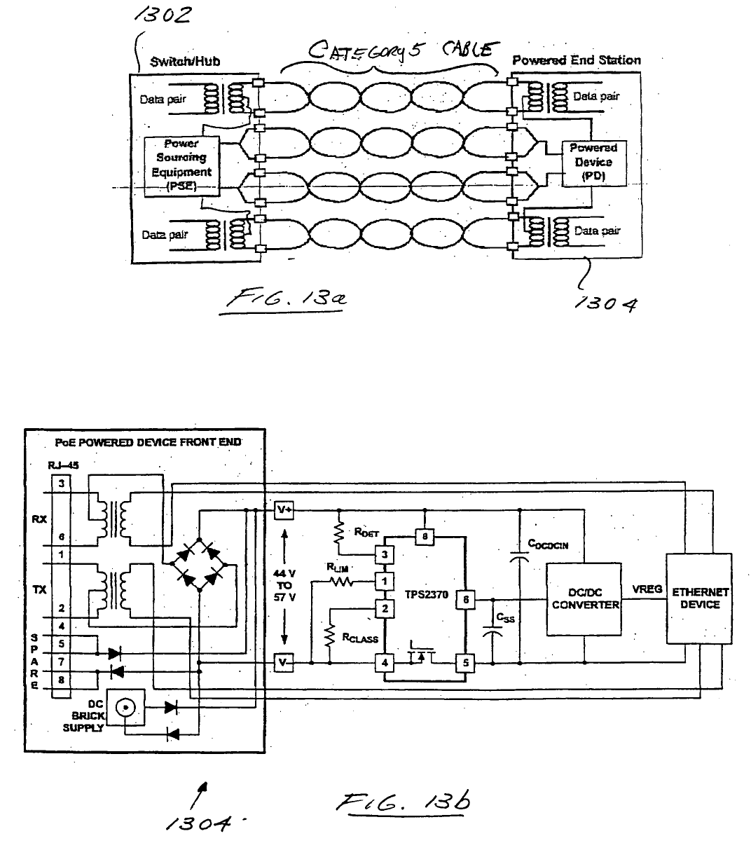

FIG. 12 illustrates one embodiment of a network configuration useful with the apparatus of FIG. 11. The communications server 102 provides a user interface through a web server software application as previously described. The client computers 1202 can access this user interface through a software application (e.g., web browser) that is capable of accessing data and communicating with the web server application. This functionality may also be provided by a distributed application (DA) architecture of the type well known in the software arts, such as where a DA client portion (DACP) and DA sever portion (DASP) of a given application are used to perform the aforementioned user interface and other functions. FIG. 12 illustrates one client computer 1202a connected to the server 102 through the Internet, and other client computers 1202b connected to the server via a LAN (or WLAN) 1210. The plurality of communications, network management and control systems implemented by the server 102 can be accessed and controlled through the user interface at the client computers 1202a, 1202b if desired. This advantageously allows the premises owner or operator to control and configure the server 102 (and hence automation functions) remotely, such as from their place of work during the day while they are away.

One advantage of the server 102 and network configuration of FIGS. 11 and 12 relates to the use of a baseband signaling interface 1170 to interface remotely with the AC power line signaling interface 1103. As is well known, AC power line signaling systems are susceptible to noise and other interference. With the present invention, the AC power line signaling interface 1103 can be co-located with the premises power distribution panel, thereby providing a maximum signal strength for transmitting the control signals from the server 102 onto the premises power distribution system. This is particularly advantageous in instances where the power distribution panel is not located near the premises communications distribution panel.

As described above, the present invention provides methods and apparatus that allow for remote control of a premises automation system using a computer connected to a local area network, WLAN, PAN, or to the Internet. One advantage of the present invention is that the user interface can be more comprehensive in nature than prior art solutions, so as to provide more information regarding the configuration, status and operation of the automation system, as well as and a much easier way to control the system. This includes even remotely monitoring one or more sensors or other data sources of the system such as for safety reasons. By obviating telephony based user interfaces, the illustrated embodiment of the invention can also reduce the cost of operating and maintaining the automation system (especially from very distant locations), since Internet, WiFi, etc. access is typically of much greater bandwidth and much less costly on a per-time basis than telephony access. However, it will be recognized that the inventions described herein may also utilize a telephony interface if desired, either as a primary or backup modality, e.g., where the user has no available internet or WiFi access, or where the user access is predominantly conducted at short range or via mobile devices without network connectivity.

Power-Over-Ethernet (POE)

Referring now to FIGS. 13a-13e, various exemplary apparatus used for providing/receiving electrical power over network interfaces (e.g., IEEE-Std. 802.3 Ethernet or the like) are described in detail. It will be appreciated that while these embodiments are described in terms of an Ethernet implementation (e.g., one compliant with IEEE-Std. 802.3af), other network architectures and protocols may be utilized such as e.g., Token Ring, X.25, etc.

As is well known, typical Ethernet configurations use 4 leads of an RJ-45 jack. FIGS. 13a-e illustrate exemplary configurations for adding line power to the Category 5 (CAT-5) cable or other bearer conductors using the 4 (or all 8) leads available. Powers of 100 watts or more are achievable with ±50V source with e.g., 1 amps (1/4 amp in each 24 gauge wire).

FIG. 13a shows the interconnection between a switch/hub 1302 and powered end station 1304. FIG. 13b shows an exemplary configuration of the powered end station 1304 showing Ethernet and internal power paths. FIG. 13c is a block diagram of an exemplary multi-port switch/hub and line power source apparatus 1306 that may be used, inter alia, with the server devices 102 previously described herein.

FIG. 13d shows an exemplary controller circuit 1308 based on an integrated circuit (IC) 1310. This circuit 1308 is used to, e.g., automatically switch the line power on and off. In the illustrated embodiment, the IC comprises a Texas Instruments TPS2383 device, although it will be appreciated that other devices (and circuit configurations) may be used with equal success.

FIG. 13e shows an exemplary plug-in module 1310 configured to derive a line powered network (e.g., Ethernet) port using HomePlug (a/v) technology. While many homes are wired with CAT-5 cable, most are not. When available, self install IP phones, cameras, audio/video, and networking may be used. However, if the house or other premises is not wired with CAT-5 cable, then HomePlug technology can be used to derive the Ethernet port as illustrated. The module 1310 includes an AC to DC converter 1312, HomePlug a/v interface 1314, and line powered Ethernet source 1316. This module 1310 may comprise a separable “plug-in” wall module as shown, or be permanently or semi-permanently wired to or mounted at the desired location. Various other configurations will be recognized by those of ordinary skill.

Fluorescent Dimmer

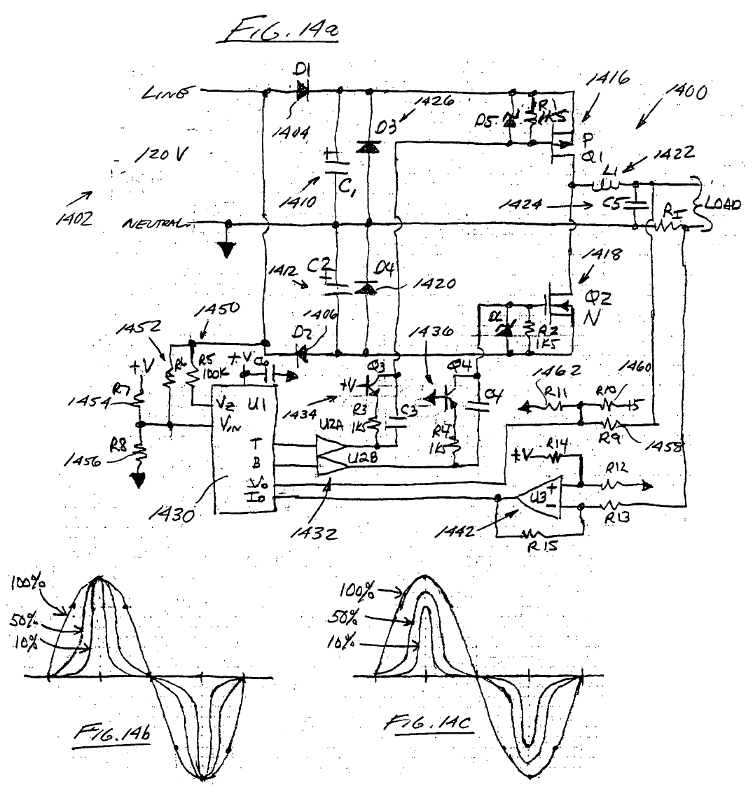

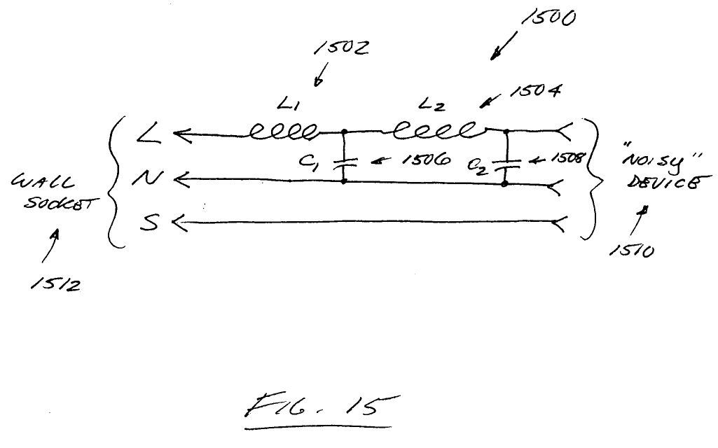

Referring now to FIGS. 14a-14c, exemplary fluorescent dimmer apparatus useful with the present invention is described.

The exemplary fluorescent dimmer apparatus of FIGS. 14a-14c accomplishes a fluorescent dimmer function by modifying the output power waveform. For traditional inductive ballast applications, the signal peak is maintained, but the width (an thus the RMS energy) is reduced as best illustrated in FIG. 14b.

The aforementioned constant peak signal approach, however, often does not work well with conventional compact (electronic) ballast devices because these electronic ballast device first rectify the AR input, and subsequently chop this new DC voltage (converted to AC). This voltage is stepped up to a higher voltage to drive the associated fluorescent lamp through a current source capacitor used within such converters. The peak voltage must also be reduced to dim the lights.

If the input capacitor of the compact fluorescent device is too large, the peak voltage will not drop sufficiently before the next ½ cycle charging of the capacitor. Another problem with some of these “chopping” circuits is that the circuit's oscillator is implemented with two transistors and a saturating transformer to create a self-oscillating state. If the magnitude of waveform is reduced, this self-oscillating functionality can be affected; e.g., causing sputtering and other undesired behavior.

In the exemplary circuit of FIG. 14a, the values of the input capacitors are purposely decreased, and the operation of the oscillator altered so as to function well at reduced input voltage. For implementations using bipolar transistors, the base drive resistor can be reduced to lower the operating voltage. Other (non-bipolar) circuits can be modified with a more voltage-independent frequency driver. FIG. 14c illustrates operation of the circuit 1400 for electronic ballast applications.

Referring to FIG. 14a, the exemplary circuit 1400 is now described in greater detail. As shown in FIG. 14a, the input line voltage 1402 is rectified with diodes D1 and D2 1404, 1406 to form a + and − peak voltage at capacitors C1 and C2 1410, 1412, where the values of C1 and C2 are small enough to allow the C1/C2 voltages to track the input voltage (specifically, the fall time of the input voltage).

The output drivers (transistors Q1, Q2 1416, 1418) operate between +V_{P} and 0 as clamped by diode D4 1420 for positive input voltage (and neutral), and between 0 and −V_{P} for negative input voltages. Q1 1416 and Q2 1418 alternate between on/off states, for 50% duty cycle at some chopping frequency (such as e.g., 64 kHz). Inductor L1 1422 and capacitor C5 1424 integrate the chopped voltage based on duty cycle, thereby giving an output of 50% of V_{P} (or 25% for 25% duty cycle, 75% for 75% duty cycle, etc.).

For negative input voltages, diode D3 1426 clamps the output chopping frequency voltage between neutral and a negative input peak value (−Vᵢₙ peak).

Therefore, the output voltage can advantageously track the input voltage by 100% to 0% based on the duty cycle of the chopping frequency.

Microcontroller U1 1430 drives Q1 1416 and Q2 1418 through the U2A/U2B dual FET driver 1432 and the level shifting transistors Q3 1434 and Q4 1436. In the exemplary embodiment, these devices 1434, 1436 are selected to provide a gain of 1, although other gains and configurations may be used. In order to prevent excessive power in the level shifting portion of the circuit 1400, the circuit is configured to use a relatively low current, which make the various (on/off/on) transitions slower, but capacitors C3 and C4 help accelerate these transitions by AC-coupling the transitions instantaneously.

To protect the circuit output from overload conditions, a current sense resistor R₁ 1440 detects the current which is amplified by amplifier U3 1442, which drives the A/D input to U1 1430. If the current exceeds the predetermined maximum, the U1 microcontroller 1430 reduces the output duty cycle in order to reduce the output current, and thus protects the output transistors Q1 1416 and Q2 1418.

Resistor R5 1450 is used to sense the input (line) zero crossings for U1 1430. Resistors R6 1452, R7 1454, and R8 1456 sense the line voltage, while resistors R9 1458, RIO 1460, and R1 11462 sense the circuit output voltage for U1 1430.

Blocking Filter

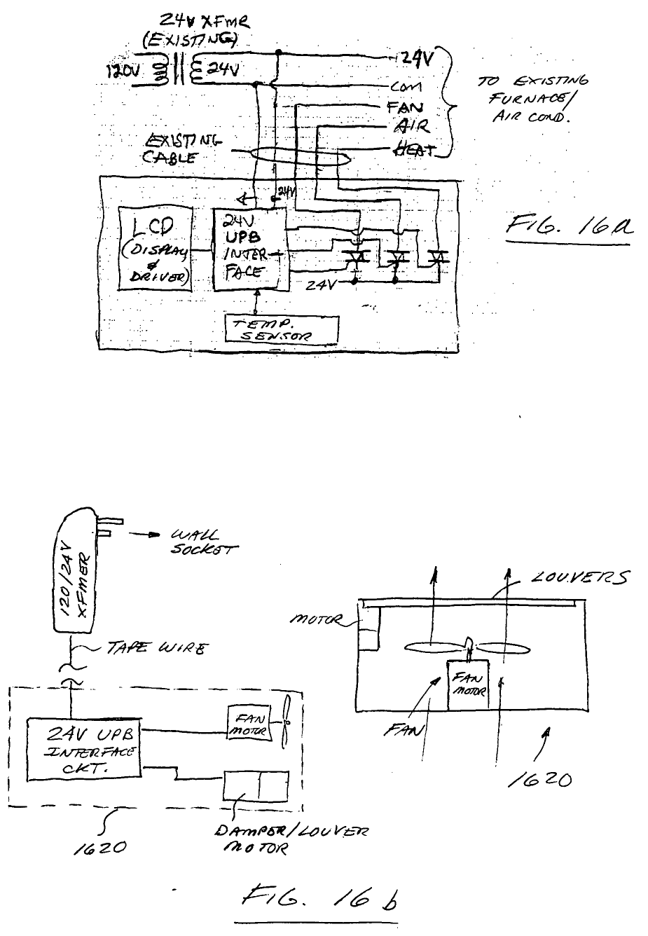

FIG. 15 illustrates an exemplary blocking filter circuit 1500 useful with the present invention. This filter 1500 may be used for, e.g., HomePlug, X-10, and UPB applications. While the illustrated circuit 1500 is adapted for mounting within a standard wall-socket plug-in module of the type manufactured by the Assignee hereof, other configurations may be used.

As shown in FIG. 15, the filter 1500 comprises a plurality of inductors L1 1502, and L2 1504 arranged with a plurality of capacitors C1 1506 and C2 1508, as is will known in the electronic filter arts. Other types and orders of filters may be used as well. The “noisy” device 1510 plugs into the module 1500 at one port, and the module plugs into the wall socket 1512 at the other port, thereby allowing filtration or blocking of the device's noise during operation.

It will be appreciated that other types (including orders) of filters may be used consistent with the invention. For example, a Chebyshev or other comparable filter may be used, and higher order circuits (e.g., third or even fourth order) may be used where the particular attributes of such circuits are desired.

HVAC

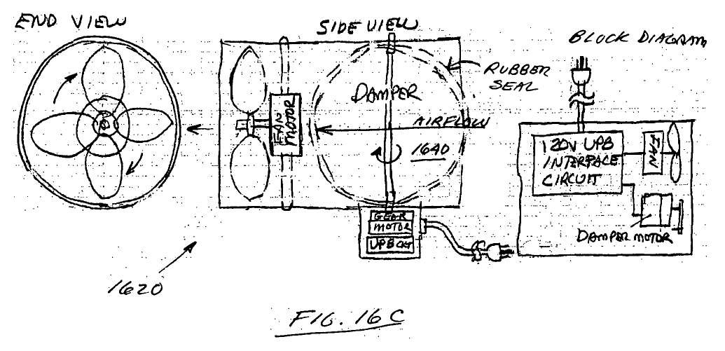

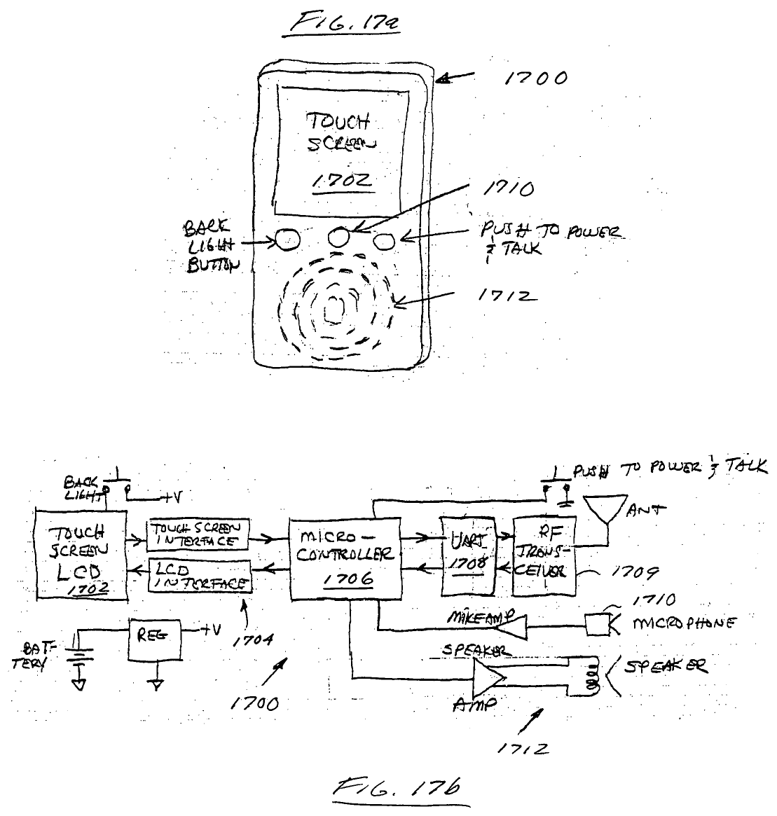

Most any home or other premises will include heating, ventilation and air conditioning (HVAC) functions which may be automated. FIG. 16a illustrates how a standard (e.g., 5-wire) thermostat can be replaced with an exemplary LCD UPB controlled thermostat 1602 by simply following standard color-code conventions for the wiring 1604 (i.e., “self-install”). This UPB thermostat 1602 can be set via the LCD touch control 1606 or other user interface like any traditional thermostat, but the remote UPB controller can also advantageously override and control the HVAC system(s). This allows for significant savings of power with very minimal installation effort and modification to the existing HVAC infrastructure at the premises.

To further save energy and control room temperatures more accurately, dampers (and optional associated “booster” fans) can be self-installed by the premises owner. The damper function (implemented using e.g., movable motor-driven or electromagnet-driven louvers or other such apparatus) provides for the selective control of air flow via the register, thereby allowing for reduced or increased flow into certain spaces of the premises. This is particularly useful where portions of the premises are not being used (and hence no HVAC service to those spaces is needed or desired). By closing the louvers in a given space, the head loss (or backpressure) into that space is increased, thereby selectively causing an increased flow into other spaces served by the HVAC system. More airflow into these other spaces increases the efficiency of the system as a whole, since the heat or cooling source will not have to operate as long to maintain the same ambient temperature. As can be appreciated, the damper controls and mechanisms can be substantially binary (i.e., open or closed), adjustable to a particular position, or anything there between.

Similarly, the optional booster fans (which can also be used without the aforementioned damper louvers) provide enhanced airflow by, e.g., reducing the backpressure within the upstream portion of the HVAC system, thereby generating a higher flow rate (e.g., CFM) into the spaces where they are used..

Three exemplary versions are illustrated (see FIGS. 16b and 16c). In one such variant, the damper apparatus 1620 sits atop of a conventional register, and provides automated control of air flow therethrough. One alternate configuration is provided with a flange that replaces the register (i.e., fits within the aperture existing for the register. In another variant (FIG. 16c), the damper/fan comprises a round shape, and mounts within the existing round cross-section duct work using conventional mounting techniques. The damper comprises a butterfly-type damper 1640 of the type well known in the art. Myriad other configurations, whether with or without fans and dampers, will be recognized by those of ordinary skill given the present disclosure.

The exemplary register apparatus of FIG. 16b is powered by a 24 VAC plug in transformer, and interconnected with the IDC tape wire (previously described herein) for easy self-installation by the premises owner. The in-line damper/fan apparatus of FIG. 16c has a 120 VAC power cord. The user simply cuts the hose to the proper dimensions, installs the round damper/fan element, tapes up the installation such as using duct tape or similar, and then plugs the element in to any wall or attic outlet.

Remote Units

FIGS. 17a and 17b illustrate one exemplary embodiment of an RF remote device 1700 according to the present invention. In the illustrated embodiment, the remote device 1700 comprises a hand-held PDA-like device with a touch screen 1702 or other user interface for flexibility and control, as well as 2-way audio capability for voice control of one or more remote devices. The 2-way voice capability allows for (i) outgoing voice-band communications (e.g., walkie-talkie functionality), (ii) voice control of one or more functions via a speech recognition algorithm; and (ii) receiving (incoming) voice communications from the server 102 or another remote device (or other voice remotes). For example, a homeowner or resident of a premises can interrogate the server 102 or another remote device situated within the premises before entering the home, to determine if anybody is or had been in the premises. This can be implemented in a variety of ways, such as e.g., where the server records all received acoustic transmissions from the various remote devices or other “listening” stations within the home for playback over the user's remote device 1700. That way, the user, can safely sit in their car for example, and listen to all sounds that have transpired during the period of their absence. Similarly, the user can switch on a “direct feed” functionality, wherein they can listen to sounds within the premises in real time to determine if there is any movement within the house.

These functions can also be coupled with the motion detectors within the premises (either recorded or in real time), such that the user can obtain an audible or visual indication of detected motion within the premises aside from any acoustic energy that was detected. For example, the user's LCD screen 1702 can display a graphic illustration of motion levels detected in varying spaces (e.g., via a bar graph indicator or the like), and may switch from room to room. This switching can be correlated with the audio monitoring, such that when the user selects a given room, both motion and audio data is presented. Myriad other approaches may be used as well.

FIG. 17b is a block diagram showing one exemplary configuration of the remote device 1700 of FIG. 17a. As shown in FIG. 17b, the device 1700 comprises the touch screen 1702 and associated interfaces 1704, a microcontroller 1706, UART 1708, RF interface (transceiver) 1709, low-noise microphone and amplifier 1710 (optionally with noise cancellation processing), and speaker and amplifier 1712. A digital signal processor (DSP), RISC processor, or other such device (not shown) may also be used in the device 1700 such as for performing speech recognition (and text-to-speech) processing within the device. Such algorithms (e.g., CELP or the like) digitally encode the user's speech to form a digitized data file which is then analyzed to recognize phonetics or other speech structures within the digitized speech that correlate to spoken words or available commands for the remote device 1700 or downstream devices such as the server 102. Alternatively, the raw speech signals or other data may be sent “raw” off-device for processing at another entity, such as the server 102.

The RF interface 1709 may comprise any number of different air interfaces including, without limitation, Bluetooth FHSS, ISM band FDMA or TDMA, IEEE-802.11 WiFi, 802.15 PAN, UWB, analog, Z-Wave, etc. An IR (e.g., IrDA) interface may also be used; however, this generally requires LOS communication and hence is therefore significantly more limited. The RF interface may also use other pathways to gain access to the server (as opposed to direct RF communications with a counterpart transceiver on the server 102), such as e.g., via a local WiFi hotspot which then connects to the server's IP address over the Internet and an installed premises DOCSIS or cable modem, via a DSL line, via a satellite or millimeter wave link, WiMAX interface, etc.

Other configurations of the remote device 1700 may also be used, such as where a miniature version (with no LCD touch screen or speaker) is provided. In this variant, the device 1700 comprises multiple predetermined function buttons akin to a vehicle remote keyless entry device. Other variants may have the LCD touch screen without audio capability, or alternatively the audio capability (one-way or two-way) yet no touch screen or display. An almost infinite number of feature combinations and configurations will be recognized.

In yet another embodiment, some or all of the foregoing features can be rendered within an existing mobile or handheld device. For example, a PDA or multifunction device having a touch screen and Bluetooth, cellular or other wireless interface may be used as the basis for one or more software routines that implement the foregoing functions. One such exemplary device comprises the Motorola A780 device, although others may be used. This device can be reprogrammed such that a software application is resident within its protocol stack, the user simply calling up the “home automation” or similar application. This application reprograms one or more soft key functions on the device, thereby allowing the user to communicate with the server 102 (or another device, such as a Bluetooth device or node). The A780 further includes indigenous speaker independent speech recognition technology, as well as a built in speaker phone and video streaming capability. Hence, the server 102 can even stream audio or video (whether pre-recorded or in real time) over the wireless link between the server and the device 1700. This wireless link may comprise the cellular air interface available on the phone (e.g., CDMA, GSM, TDMA, etc.), or the Bluetooth short range interface. For example, in one variant, a Bluetooth node in communication with the server 102 is placed in the user's garage, or near the front door. The user can use their mobile phone (e.g., A780) or other such device to query the node and retrieve the stored or real time video/audio from within the house. This streamed video/audio can be played out right on the user's phone, thereby obviating the user having to carry multiple devices.

Water Control

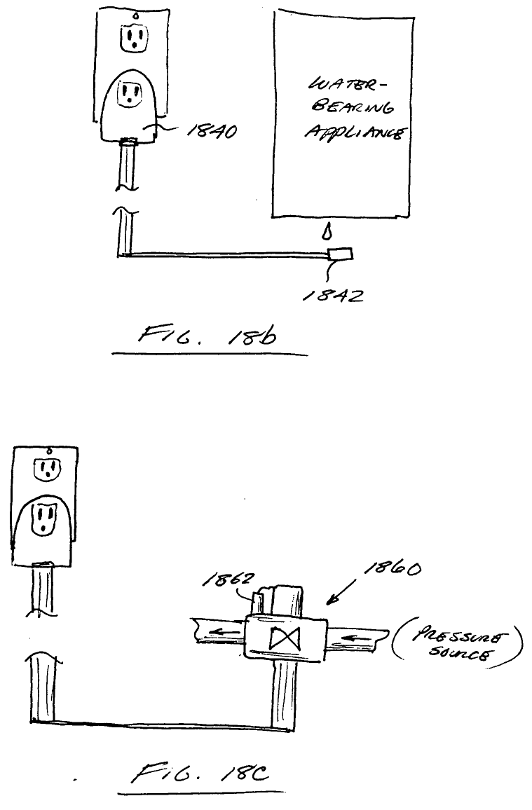

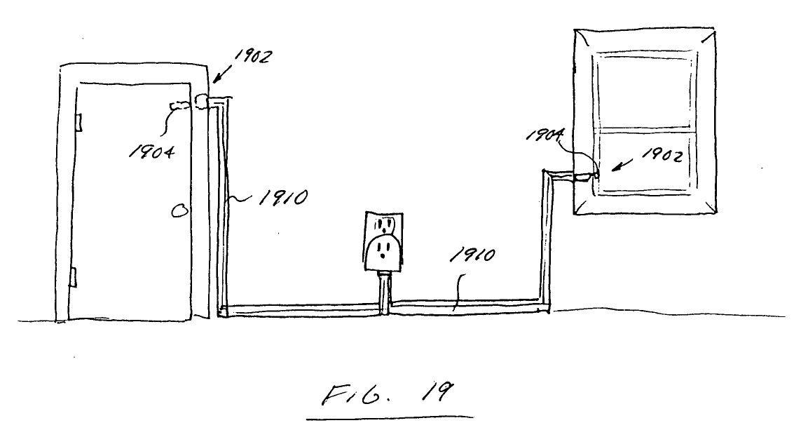

FIG. 18a illustrates an exemplary embodiment of a user-installable hot water re-circulation module 1800 according to the invention. The recirculation module 1800 is located, e.g., at the farthest sink from the hot water heater within the premises. The illustrated module 1800 and related components are installed by the homeowner or user by inserting “T” adapters 1803 on the supply lines 1801 to the water valves 1802 and installing hoses 1804 to a pump assembly 1806. The pump 1806 is mounted (e.g., screwed or otherwise mated) to a nearby wall or other structure, and plugged into a local 120 VAC or similar electrical receptacle. The pump assembly 1806 has a built-in temperature sensor 1809 to determine when to shut off the pump motor. The assembly 1806 is also fitted with a check valve 1811 that prevents cold water from mixing with hot water. The pump is normally controlled by the timer function set in the scheduler module of the server/controller 102. It can also be initiated by a UPB transmitter.

FIG. 18b shows an exemplary configuration of a water sensor module 1840 connected through a tape wire and IDC “button” arrangement (previously described herein) to moisture sensors 1842 placed in one or more locations of interest; e.g., under a water heater, washer/dryer, refrigerator, sink, etc. to monitor for water leaks from these devices. When a leak is sensed, a UPB signal is sent by the module 1840 to a control point within the system; e.g., a master shut off valve located at the input to the premises, or to the scheduler or server/controller in charge of the premises automation functions. This allows both the source of the water supplying the leaking device to be secured (thereby eventually terminating the leak), as well as performance of notification and recordation functions, such as sounding an audible alarm, sending an electronic message or transmission (e.g., e-mail, SMS message, RF wireless packet, etc.) to a remote monitoring entity, recording the time, date, and location of the leak, etc. Test and maintenance functions of the sensors 1840 can also be remotely performed.

FIG. 18c illustrates an exemplary water shut-off valve and sensing apparatus 1860. This valve may comprise, e.g., a solenoid operated isolation valve, or any number of different configurations. The apparatus has a pressure sensor on the premises-side of the valve that allows the apparatus controller (or a remote entity, such as the server 102) to verify system integrity and test for leaks by shutting the valve, and monitoring the pressure sensor 1862 output to identify any pressure drop indicating a leak in the premises side system. This function can be coordinated with other functions or uses within the premises; i.e., such that it is only performed when no other water-consuming appliances or systems are in operation, thereby avoiding “false positive” indications of leakage.

Similarly, the pressure sensor of the apparatus 1860 can be used to monitor for other undesirable conditions within the downstream or premises side of the valve. For example, an excessive pressure drop at the instant a sprinkler valve is opened can also indicate an open or missing sprinkler head.

Door and Window Position Sensors

FIG. 19 shows an exemplary position sensor configuration wherein a module 1900 is connected to a sensor 1902 in a door and/or window. A small diameter hole is drilled from the door or window molding into the door or window. A magnet 1904 is installed in the window or door and a magnetic sensor 1902 is installed in the jam, with the wires emerging from the molding where and attached using a button connection of the type previously described herein, or similar approach. The tape wire 1910 is run down the molding to the baseboard and across the baseboard to the module 1900 and terminated.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1. A premises automation system adapted for user installation, comprising:
a plurality of user-installable sensors each adapted to perform at least one sensing function related to one of the HVAC, lighting, or water systems of said premises;
a controller in signal communication with said sensors via the electrical power distribution wiring of said premises; and
a plurality of user-installable control modules, each of said modules being disposed in electrical communication with said distribution wiring and at least one of said sensors;
wherein said system is adapted to substantially automate the operation of at least one portion of said HVAC, lighting, or water systems within said premises based at least in part on signals obtained from said sensors.

2. The system of claim 1, wherein said controller comprises a server, and said server provides an integrated user interface for control of said automation system.

3. The system of claim 1, wherein said controller comprises a server that is user-serviceable and comprises a plurality of user-removable functional modules.

4. The system of claim 1, wherein at least one of said control modules comprises a power distribution-to-LAN conversion module.

5. The system of claim 1, wherein at least a portion of said sensors and respective ones of said control modules are interconnected using tape wire and at least one insulation displacement connector (IDC).

6. Integrated low cost automation apparatus comprising:
a plurality of sensors disposed at least proximate to a premises; and
a server in operative communication with said sensors via at least one installed wiring systems of said premises;
wherein said apparatus is adapted to substantially automate the operation of at least one device within said premises based at least in part on signals obtained from said sensors.

7. The apparatus of claim 6, wherein said sensors comprise moisture sensors.

8. The apparatus of claim 6, wherein said at least one installed wiring system comprises a low voltage AC power delivery system.

9. The apparatus of claim 7, wherein said at least one device comprises a water isolation valve.

10. The apparatus of claim 6, wherein said at least one sensor comprises a temperature sensor, and said at least one device comprises an HVAC component.

11. The apparatus of claim 8, further comprising a module in operative communication with said power delivery system, said module also being in electrical communication with said at least one sensor is adapted for user.

12. User-installable control apparatus adapted to control at least one aspect of the operation of a premises apparatus via commands received over the installed electrical wiring of the premises from a substantially centralized computer device.

13. The control apparatus of claim 12, wherein said centralized computer device comprises a modular server.

14. The control apparatus of claim 13, wherein said control apparatus comprises a plug-in module adapted to be received in an electrical outlet.

15. The control apparatus of claim 12, wherein said control apparatus further comprises:
a plug-in control module;
a local control apparatus adapted to perform at least one control function at said premises apparatus; and
a tape wiring bundle adapted to pass electrical current between said control module and said local control apparatus.

16. The control apparatus of claim 15, wherein said at least one control function comprises a function selected from the group consisting of water leak detection and water supply isolation.

17. The control apparatus of claim 15, wherein said at least one control function comprises environmental control.

18. The control apparatus of claim 17, wherein said at least one control apparatus comprises a ventilation damper module adapted to selectively control airflow.

19. User-installable apparatus adapted to provide hot water recirculation within a premises, comprising:
a water pump adapted for installation at a distant water-providing location within said premises;
a motive source operatively coupled to said pump;
a first fixture adapted to provide a supply of water from a first line to said pump;
a second fixture adapted to discharge said water received from said first line to a second line under force of said pump; and
a temperature sensor operatively coupled to said motive source, said sensor adapted to secure said motive source upon said water from said first line reaching a predetermined temperature.

20. The apparatus of claim 19, further comprising a check valve disposed so as to prevent backflow through said pump when said motive source is not operating.

21. The apparatus of claim 20, wherein said motive source comprises an electric motor.

22. The apparatus of claim 21, wherein said distant location comprises a sink disposed farthest from a water heater supplying said first line.

23. The apparatus of claim 22, wherein at least said pump, motive source, and first and second fixtures are all user-installable.

24. Home automation apparatus installed using the method comprising:
providing a controller apparatus;
providing a plurality of control modules;
providing a plurality of local control devices;
providing a plurality of tape wire conductors;
disposing said controller apparatus in electrical communication with an electrical distribution system of said home;
disposing said local control devices at least proximate to respective ones of a plurality of apparatus to be controlled;
disposing said control modules at least proximate to respective ones of said local control devices and in electrical communication with said electrical distribution system; and
forming an electrical pathway between said control modules and said local control devices using said tape wire conductors.

25. The apparatus of claim 24, wherein said controller apparatus comprises a modular server.

26. The apparatus of claim 24, wherein said control modules comprises a plug-in module adapted to be received within a wall socket.

27. The apparatus of claim 24, further comprising a plurality of insulation displacement-based connectors, said connectors interfacing with said tape wire conductors so as to facilitate user installation.

28. Scalable, user-installable premises automation apparatus comprising a controller apparatus; at least one control module, at least one local control device, and at least one user-installable conductor set, said automation apparatus being installed using the method comprising:
disposing said controller apparatus in electrical communication with an electrical distribution system of said home;
disposing said local control device at least proximate to an apparatus to be controlled;
disposing said control module at least proximate to said local control device and in electrical communication with said electrical distribution system; and
forming an electrical pathway between said control module and said local control device using said tape wire conductors;
wherein said controller apparatus is adapted to utilize one or more additional ones of said control modules and local control devices.

29. Sever apparatus adapted for use in a premises automation system, comprising:
a processor;
memory in data communication with said processor;
a mass storage device in data communication with said processor; and
a powerline interface adapted to at least send control signals over installed wiring within said premises to a plurality of control modules.

30. The server apparatus of claim 29, further comprising an interface with telephone wiring installed in said premises, said server being adapted to send signals over said telephone wiring to at least one computer device connected thereto.

31. The server apparatus of claim 29, further comprising an interface with twisted pair network wiring installed in said premises, said server being adapted to send signals over said network wiring to at least one computer device connected thereto.

32. The server apparatus of claim 29, further comprising a wireless interface for communicating with a WLAN device disposed at least proximate to said premises.

33. The server apparatus of claim 29, wherein said powerline interface is adapted to communicate using a plurality of different powerline protocols, at least a portion of said plurality selected form the group consisting of UPB and HomePlug.

34. The server apparatus of claim 29, further comprising an RF interface for communicating with a coaxial cable network serving said premises.

35. A home automation system adapted for user installation, comprising:
a plurality of user-installable local devices each adapted to perform at least one sensing or control function related to one of the HVAC, lighting, or water systems of said premises;
a controller in signal communication with said local devices via the electrical power distribution wiring of said premises;
a plurality of user-installable control modules, each of said modules being disposed in electrical communication with said distribution wiring and at least one of said local devices; and
user-installable tape wiring and associated insulation displacement connectors, said tape wiring and connectors electrically coupling each of said local devices to a respective one of control modules;
wherein said system is adapted to substantially automate the operation of at least one portion of said HVAC, lighting, or water system within said premises based at least in part on signals obtained from said local devices.

36. User-installable premises lighting apparatus, comprising:
a fixture comprising a plurality of light-emitting diodes;
a control module adapted for plugging into a wall outlet connected to the electrical distribution system of said premises; and
at least one wire bundle adapted to electrically interface said fixture with said control module;
wherein said control module is adapted to receive command signals from a remote entity over said distribution system and control at least one aspect of the operation of said fixture.

37. The lighting apparatus of claim 36, wherein said control module and wire bundle supply electrical power to said fixture.

38. The lighting apparatus of claim 37, wherein said wire bundle comprises a tape wire bundle having at least one insulation displacement connector associated therewith.
